(19) United States
(12) Patent Application Publication
(10) Pub. No.: US 2015/0218391 A1
(43) Pub. Date: Aug. 6, 2015

(54) SILVER PASTE COMPOSITION AND METHOD FOR PRODUCING THE SAME

(71) Applicant: NAMICS CORPORATION, Niigata-shi, Niigata (JP)

(72) Inventors: Tomoyuki Takahashi, Niigata (JP); Noriyuki Sakai, Niigata (JP); Akito Yoshii, Niigata (JP)

(73) Assignee: NAMICS CORPORATION, Niigata-shi, Niigata (JP)

(21) Appl. No.: 14/426,607

(22) PCT Filed: Sep. 5, 2013
(86) PCT No.: PCT/JP2013/073874

§ 371 Date: Mar. 6, 2015

(30) Foreign Application Priority Data
Sep. 7, 2012 (JP) 2012-196806

(51) Int. Cl. C09D 5/24; B22F 9/24; C22B 3/00; H01B 1/22; C22C 5/06

(52) U.S. Cl. CPC C09D 5/24; H01B 1/22; C22C 5/06; C22B 11/04; B22F 9/24

(57) ABSTRACT

A silver paste composition that includes (A) silver particles that are spherical and have continuous open pores, and a (B) resin and/or a (C) dispersant, and that preferably further comprises at least one substance selected from the group consisting of a (D) curing agent, a (E) fluxing agent, and a (F) curing accelerator. The silver paste composition serves to suppress an increase in electrical resistance and viscosity and reduces the electrical resistivity.

### FIELD OF THE INVENTION

The present invention relates to a silver paste composition comprising silver particles that are spherical and have continuous open pores, and a resin, and a method for producing the same.

### BACKGROUND ART

Conventionally, a conductive powder intended to obtain a conductive material having low electrical resistivity for use in an electronic device and others (patent document 1) has been known. The conductive powder disclosed in patent document 1 is obtained by an electroless method in which dendritic crystals of, for example, silver or copper are grown from a nucleus substance, such as a silica particle, as the center, and this conductive powder has protruding portions extending in a radial pattern and depressed portions in the spaces between the protruding portions.

Recently, there have been increasing demands for a microwiring circuit for use in an electronic device and others, and a conductive material used in a microwiring circuit is disclosed (patent document 2). The conductive material in patent document 2 is a dendritic silver powder obtained from an aqueous solution containing silver nitrate and L-ascorbic acid by an electroless wet process. Further, as a conductive material used in a microwiring circuit, a flat or flaky silver powder has been known (patent document 3). The flat or flaky silver powder in patent document 3 is obtained by a wet reduction method in which to a silver ion solution containing silver nitrate, citric acid, and gelatin is added a reducing agent such as an ascorbic acid-based reducing agent. Further, as a silver powder used in a microwiring circuit, a spherical silver powder has also been known (patent documents 4 to 6). The silver powder in patent documents 4 to 6 is obtained by a method in which aqueous ammonia is added to a silver nitrate solution to form a silver amine complex solution, and sodium hydroxide is added as a pH adjustor to the resultant solution, and further a formalin solution as a reducing agent is added, and then stearic acid as a dispersant is added.

The dendritic silver powders disclosed in patent documents 1 and 2 are of a relatively sparse structure having large porosity. The silver powders disclosed in patent documents 1 and 2 are disadvantageous in that when the silver powder and a resin are mixed together to produce a conductive composition, the dendritic portions of the powder are likely to be interlocked with one another to cause aggregation of the composition being produced, making it difficult to apply the silver powder to microwiring. For this reason, it may not be possible to achieve low electrical resistance using the silver powders disclosed in patent documents 1 and 2. Further, with respect to the spherical silver powder disclosed in patent documents 4 to 6, as specifically described in the working Examples, the volume-based cumulative 50% particle diameter D50 of the silver particles is 1.5 but the BET specific surface area of the silver particles is as small as 0.77 m²/g. From this, it is presumed that the spherical silver powder disclosed in patent documents 4 to 6 is a spherical silver powder having a relatively even, smooth surface. The silver powder in patent documents 4 to 6 has a disadvantage in that when the silver powder and a resin are mixed together to produce a conductive composition, the silver powder particles may not be in good contact with one another, so that the conductivity is lowered, making it impossible to reduce electrical resistance.

Spherical metal particles having micropores have been disclosed (patent document 7), although the metal particles are not for use in a conductive material, such as a microwiring circuit, but are used as a binder for use in manufacturing a cutting tool for a hard material, such as diamond. The spherical metal particles in patent document 7 are spherical porous particles of basic cobalt carbonate. The spherical porous particles of basic cobalt carbonate in patent document 7 are produced by, for example, a method in which a hydrogencarbonate salt is added to an aqueous cobalt(II) salt solution at 60 to 90° C. while vigorously stirring, to obtain spherical basic cobalt carbonate, and then the obtained cobalt carbonate is converted to spherical cobalt(II) hydroxide by adding an alkali and/or ammonia solution, and then the resultant cobalt(II) hydroxide is contacted with a gaseous reducing agent at 300 to 900° C. Further, with respect to spherical porous alloy particles, a method for producing spherical porous metal particles comprising palladium and silver is disclosed (patent document 8). Patent document 8 discloses, as a method for producing spherical porous metal particles comprising palladium and silver, a method that comprises adding a polymer having a chelating group to an aqueous solution containing a palladium salt and a silver salt to form a metal-supported chelating resin having palladium ions and silver ions supported by forming a complex therefrom, and calcining the formed resin in the presence of oxygen to burn and remove the organic components, and then calcining the resultant material in a hydrogen atmosphere.

However, the spherical porous metal particles disclosed in patent document 7 or 8 are disadvantageous in that temperature control and cumbersome operations are needed, and that the particles cannot be produced at a low cost and with ease. Further, it is unclear whether or not the spherical porous metal particles disclosed in patent document 7 or 8 are suitable for use in a conductive material that can reduce electrical resistance and can be applied to a microwiring structure.

### PRIOR ART REFERENCES

### Patent Documents

Patent document 1: Japanese Unexamined Patent Publication No. 2004-149903
Patent document 2: Japanese Unexamined Patent Publication No. 2005-146387
Patent document 3: Japanese Unexamined Patent Publication No. 2009-13449
Patent document 4: Japanese Unexamined Patent Publication No. 2006-2228
Patent document 5: Japanese Unexamined Patent Publication No. 2006-97086
Patent document 6: Japanese Unexamined Patent Publication No. 2006-193795
Patent document 7: Japanese Unexamined Patent Publication No. Hei 11-505884
Patent document 8: Japanese Unexamined Patent Publication No. 2008-115439

### DISCLOSURE OF THE INVENTION

### Problems to be Solved by the Invention

The silver paste composition of the present invention comprises silver particles that are spherical and have continuous open pores, and a resin, and exhibits such excellent properties as suppressing an increase in electrical resistance and viscosity, and reducing electrical resistivity. A task of the present invention is to provide a silver paste composition that can be advantageously used in, for example, forming a conductor or an electronic part, and a method for producing the same.

### Means to Solve the Problem

The present invention is directed to:

[1] a silver paste composition that comprises: (A) silver particles that are spherical and have continuous open pores, and a (B) resin and/or a (C) dispersant;

[2] the silver paste composition according to item [1] above, wherein a (B) resin is contained in the silver paste composition, and the mass ratio of the (A) silver particles to the (B) resin is 30:70 to 99:1;

[3] the silver paste composition according to item [1] or [2] above that further comprises a (D) curing agent;

[4] the silver paste composition according to any one of items [1] to [3] above that further comprises at least one member selected from among a (E) fluxing agent and a (F) curing accelerator;

[5] the silver paste composition according to item [4] above, wherein the continuous open pores of the (A) silver particles contain at least one member selected from among a (B) resin, a (C) dispersant, a (D) curing agent, a (E) fluxing agent, and a (F) curing accelerator;

[6] the silver paste composition according to item [5] above, wherein the amount of the substance contained in the continuous open pores of the (A) silver particles is 1 to 50% by mass, based on the total mass of the (A) silver particles and the substance contained;

[7] the silver paste composition according to any one of items [1] to [6] above, wherein the (A) silver particles have a volume-based cumulative 50% particle diameter D50 of 0.5 to 6 μm, as measured by a particle size distribution measurement method based on image analysis;

[8] the silver paste composition according to any one of items [1] to [7] above, wherein the (A) silver particles have a BET specific surface area of 1 to 8 m²/g;

[9] the silver paste composition according to any one of items [1] to [8] above, wherein the (A) silver particles have a volume-based cumulative 10% particle diameter D10 of 0.5 to 2.5 μm, a volume-based cumulative 90% particle diameter D90 of 3 to 6 μm, and a D90/D10 of 1.5 to 2.5, as measured by a particle size distribution measurement method based on image analysis;

[10] the silver paste composition according to any one of items [1] to [9] above, wherein 3≦K≦72, the value K being expressed by equation (2), which is calculated from the specific surface area SS of the (A) silver particles expressed by equation (1) and the BET specific surface area BS of the (A) silver particles.

SS=6/μd (1)
wherein ρ represents the theoretical density of the (A) silver particles that contain no resin in the continuous open pores, and d represents the volume-based cumulative 50% particle diameter D50 of the (A) silver particles, as measured by a particle size distribution measurement method based on image analysis,

K=SS/BS×100 (2)
wherein SS is the specific surface area of the (A) silver particles expressed by the equation (1) above, and BS is the specific surface area of the (A) silver particles, as measured by the BET method;

[11] the silver paste composition according to any one of items [1] to [10] above, wherein the (B) resin is at least one resin selected from the group consisting of a thermoplastic resin and a thermosetting resin;

[12] the silver paste composition according to item [11] above, wherein the (B) resin is a thermoplastic resin, said thermoplastic resin being at least one resin selected from the group consisting of a polystyrene resin, an acrylic resin, a polycarbonate resin, a polyamide resin, a polyamide-imide resin, and a liquid thermoplastic elastomer having a glass transition temperature of 25° C. or lower and being in a liquid state or being dissolved in an organic solvent;

[13] the silver paste composition according to item [11] above, wherein the (B) resin is a thermosetting resin, said thermosetting resin being at least one resin selected from the group consisting of an epoxy resin, a cyanate resin, a urethane resin, and an unsaturated polyester resin;

[14] the silver paste composition according to any one of items [1] to [13] above, wherein the (C) dispersant is at least one dispersant selected from the group consisting of a fatty acid or a salt thereof, a surfactant, an organometal, and a protective colloid;

[15] the silver paste composition according to any one of items [3] to [14] above, wherein the (D) curing agent is at least one curing agent selected from the group consisting of a phenolic curing agent, an amine curing agent, an imidazole curing agent, and an acid anhydride curing agent;

[16] the silver paste composition according to any one of items [4] to [15] above, wherein the (E) fluxing agent is at least one fluxing agent selected from the group consisting of a rosin fluxing agent, a modified rosin fluxing agent, and an organic acid fluxing agent;

[17] the silver paste composition according to any one of items [4] to [16] above, wherein the (F) curing accelerator is at least one curing accelerator selected from the group consisting of an imidazole and a tertiary amine.

The present invention is directed to:

[18] a conductor that is formed using the silver paste composition according to any one of items [1] to [17] above.

The present invention is directed to:

[19] an electronic part that is formed using the silver paste composition according to any one of items [1] to [17] above.

The present invention is directed to:

[20] a method for producing a silver paste composition, wherein the method comprises the steps of: adding a silver salt and a polycarboxylic acid to a liquid phase to obtain an aqueous solution containing silver ions; then adding a reducing agent to the obtained aqueous solution to cause, in the liquid phase, precipitation of silver particles that have continuous open pores; and mixing the obtained (A) silver particles that have continuous open pores and a (B) resin with each other;

[21] the method for producing a silver paste composition according to item [20] above, wherein the silver salt is at least one silver salt selected from the group consisting of silver nitrate, silver sulfate, silver carbonate, and silver chloride;

[22] the method for producing a silver paste composition according to item [20] or [21] above, wherein the polycarboxylic acid is at least one polycarboxylic acid selected from the group consisting of citric acid, malic acid, maleic acid, and malonic acid;

[23] the method for producing a silver paste composition according to any one of items [20] to [22] above, wherein the reducing agent is ascorbic acid;

[24] the method for producing a silver paste composition according to any one of items [20] to [23] above, wherein the ratio of the amounts of the silver salt, polycarboxylic acid, and reducing agent added, in terms of molar ratio, is 1:0.1 to 0.5:0.5 to 1.

### Effect of the Invention

The present invention provides a silver paste composition that has excellent properties for use as a conductive material and that can suppress an increase in viscosity, suppress an increase in electrical resistivity, and reduce electrical resistivity while maintaining the elastic modulus and strength.

### BRIEF DESCRIPTION OF THE DRAWINGS

FIG. 1 is an SEM photomicrograph of the cross-section of silver particles that are spherical and have continuous open pores (silver particles a), taken at a magnification of 20,000 times.

FIG. 2 is an SEM photomicrograph of silver particles that are spherical and have continuous open pores (silver particles a), taken at a magnification of 20,000 times.

FIG. 3 is an SEM photomicrograph of silver particles that are spherical and have continuous open pores (silver particles a), taken at a magnification of 40,000 times.

FIG. 4 is an image-processed SEM photomicrograph of the cross-section of silver particles that are spherical and have continuous open pores (silver particles a), taken at a magnification of 20,000 times, showing the region SA of void portions.

FIG. 5 is an SEM photomicrograph of silver particles b which do not have continuous open pores, taken at a magnification of 5,000 times.

FIG. 6 is an SEM photomicrograph of silver particles c in flake form, taken at a magnification of 2,000 times.

FIG. 7 shows SEM photomicrographs taken at a magnification of 2,000 times, showing the appearance of silver paste compositions, obtained by mixing silver particles a to c with ethyl cellulose, and then calcined at different temperatures.

FIG. 8 shows SEM photomicrographs of silver particles a, and surface-treated silver particles obtained by mixing together silver particles a and a dispersant, taken at magnifications of 10,000 times ((a) to (c)), and 5,000 times ((d)).

### BEST MODE FOR CARRYING OUT THE INVENTION

In the following, embodiments for carrying out the present invention will be described in detail with references to drawings.

The present invention is a silver paste composition that comprises (A) silver particles that are spherical and have continuous open pores, a (B) resin and/or a (C) dispersant.

[(A) Silver Particles]

(A) silver particles used in the silver paste composition of the present invention are spherical and have continuous open pores. (A) Silver particles used in the present invention can contain a component, such as a (B) resin, in the continuous open pores of the (A) silver particles. By virtue of containing (A) silver particles that have continuous open pores and a (B) resin, the silver paste composition of the present invention suppresses an increase in viscosity while maintaining the elastic modulus and strength, as compared to a silver paste composition comprising silver particles having no continuous open pores and a resin. The silver paste composition of the present invention can suppress an increase in electrical resistivity and reduce electrical resistivity, and thus has excellent properties as a conductive material. Further, by virtue of containing (A) silver particles that have continuous open pores and a (C) dispersant, the silver paste composition of the present invention has the (C) dispersant contained in the continuous open pores of the (A) silver particles and, moreover, the surfaces of the (A) silver particles are treated with the (C) dispersant, making it possible to prevent the (A) silver particles from aggregation. The silver paste composition of the present invention comprises (A) silver particles that have continuous open pores, a (B) resin, and a (C) dispersant, and, by curing the silver paste composition, a conductor in the form of a uniform and dense thin film can be obtained, so that the electrical resistivity of the conductor can be reduced.

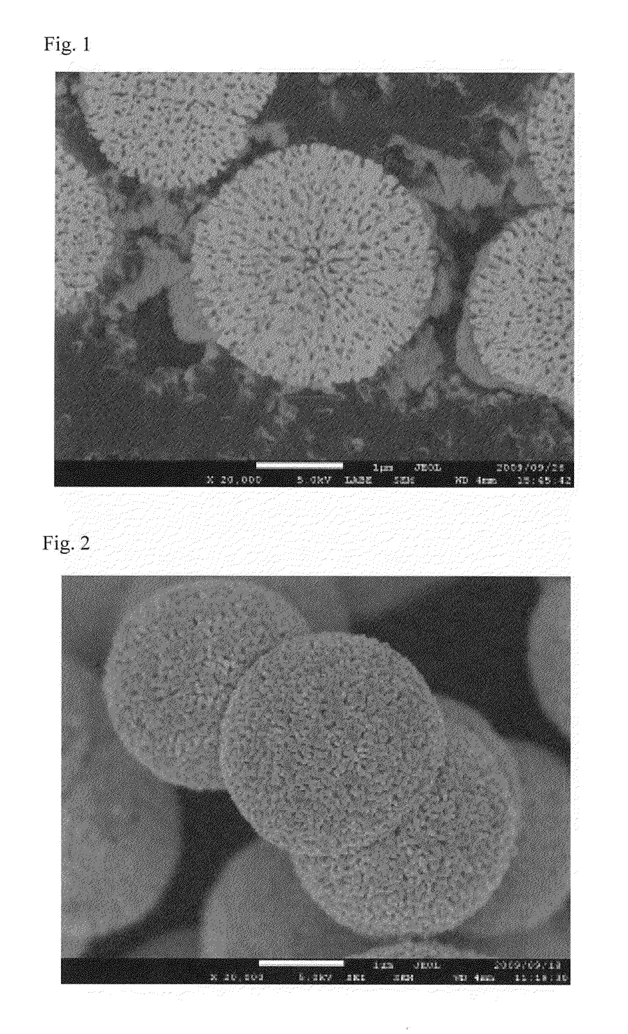

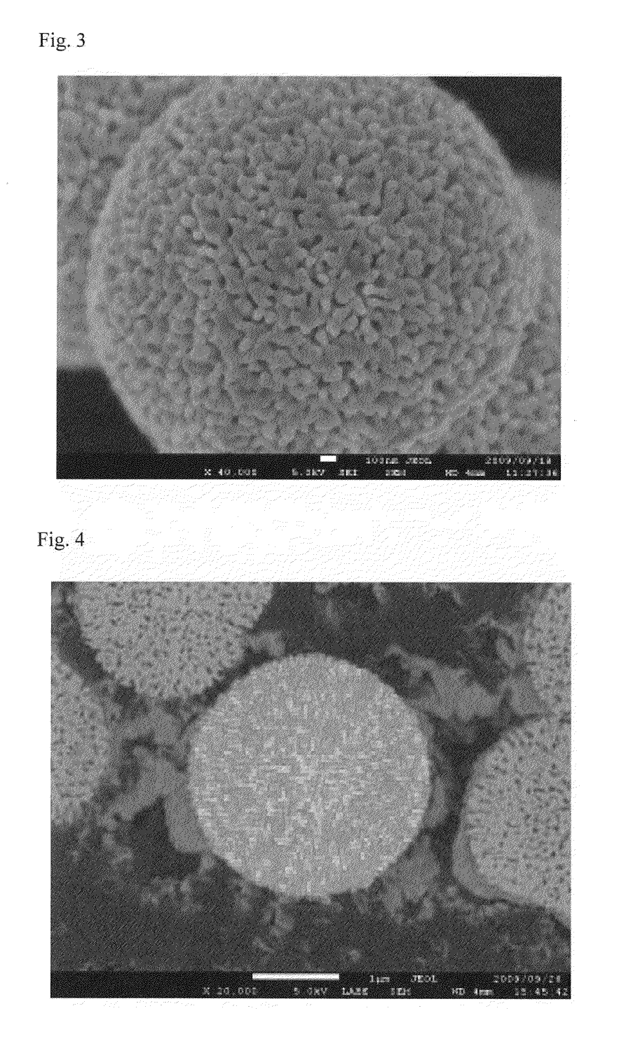

FIG. 1 shows an image (magnification: 20,000 times) of an ion-milled cross-section of (A) silver particles used in the present invention, which are spherical and have continuous open pores, taken by a scanning electron microscope (SEM). FIGS. 2 and 3 show images of the external appearance of (A) silver particles that are spherical and have continuous open pores, taken by a scanning electron microscope (SEM) at respective magnifications of 20,000 times and 40,000 times. FIG. 4 shows a processed image (magnification: 20,000 times) of an ion-milled cross-section of (A) silver particles that are spherical and have continuous open pores, taken by a scanning electron microscope (SEM), showing the region SA of void portions.

As shown in FIG. 1, (A) silver particles used in the silver paste composition of the present invention are spherical and have continuous open pores. The silver paste composition of the present invention comprises (A) silver particles and a (B) resin and/or (C) dispersant, and therefore the (B) resin and/or (C) dispersant can be contained in the continuous open pores of the (A) silver particles.

As shown in FIG. 1 or FIG. 4, the silver particles contained in the silver paste composition of the present invention have a structure formed through crystal growth from the center outwardly and uniformly into a dendrite. The silver particles do not grow into thin crystal needles but grow into a crystal dendrite such that the ends of branches form a spherical surface that has a finely even structure. The silver particles are formed through crystal growth into a nearly perfect sphere such that the inside of the sphere has a multitude of continuous open pores.

As shown in FIG. 1, the silver particles contained in the silver paste composition of the present invention have a cross-section in a coral form when the silver particles do not contain a resin and the like in the continuous open pores. As shown in FIGS. 2 and 3, the silver particles contained in the silver paste composition of the present invention have an external appearance like a marimo ball (Aegagropila linnaei).

As shown in FIGS. 1 to 4, the silver particles that are spherical and have continuous open pores are comprised of crystals that have grown into a dense and uniform dendrite. The silver particles contained in the silver paste of the present invention have a spherical surface having an uneven structure that is so fine that the uneven surfaces of the individual particles do not intermesh with each other, and therefore the silver particles are unlikely to be bonded together or suffer aggregation, and hence exhibit excellent dispersibility. The silver particles contained in the silver paste of the present invention, unlike metal particles that have grown into crystal needles, do not suffer breakage of end portions when dispersed, and therefore easy control of the specific gravity and the electrical resistivity of the silver paste composition can be achieved.

<Volume-Based Cumulative 50% Particle Diameter D50>

The silver particles that are spherical and have continuous open pores preferably have a volume-based cumulative 50% particle diameter D50 of 0.5 to 6 μm, preferably 0.8 to 5 μm, more preferably 1 to 4 μm, as measured by a particle size distribution measurement method based on image analysis. As used in the present specification, the volume-based cumulative 50% particle diameter D50, cumulative 90% particle diameter D90, and cumulative 10% particle diameter D10, as measured by a particle size distribution measurement method based on image analysis, refer to the volume-based cumulative 50% particle diameter D50, cumulative 90% particle diameter D90, and cumulative 10% particle diameter D10, respectively, that are determined by observing the silver particles using a scanning electron microscope (SEM), measuring individual particles by running the image analysis-based particle size distribution measurement software “Mac-View” Ver. 1, developed by Mountech Co., Ltd., on the information in the files of images of the silver particles taken at a predetermined magnification, and then making measurements for 50 randomly selected silver particles.

<Volume-Based Cumulative 10% Particle Diameter D10 and Cumulative 90% Particle Diameter D90>

It is preferred that (A) silver particles have a volume-based cumulative 10% particle diameter D10 of 0.5 to 2.5 μm and a volume-based cumulative 90% particle diameter D90 of 3 to 6 μm, as measured by a particle size distribution measurement method based on image analysis, and that D90/D10 be 1.5 to 2.5. When (A) silver particles have a D10 of 0.5 to 2.5 μm and a D90 of 3 to 6 μm and D90/D10 is 1.6 to 2.5, the dispersion of the particle diameters of (A) silver particles is small, the particle size distribution is sharp, and the particles are of nearly equal size. When (A) silver particles have a D10 of 0.5 to 2.5 μm and a D90 of 3 to 6 μm and D90/D10 is 1.6 to 2.5, the (A) silver particles have excellent dispersibility in the silver paste composition, and suppress an increase in viscosity and electrical resistivity while maintaining the elastic modulus and strength. Further, when (A) silver particles have a D10 of 0.5 to 2.5 μm and a D90 of 3 to 6 μm and D90/D10 is 1.6 to 2.5, the (A) silver particles are excellent as a conductive material that can reduce electrical resistivity. It is more preferred that (A) silver particles have a D10 of 0.8 to 2.4 μm and a D90 of 3.5 to 5.5 μm, as measured by a particle size distribution measurement method based on image analysis, and that D90/D10 be 1.5 to 2.4. It is further preferred that (A) silver particles have a D10 of 1 to 2.4 μm and a D90 of 4 to 5 μm, as measured by a particle size distribution measurement method based on image analysis, and that D90/D10 be 1.7 to 2.3.

<BET Specific Surface Area>

(A) silver particles that are spherical and have continuous open pores preferably have a specific surface area of 1 to 8 m²/g, more preferably 2 to 7 m²/g, further preferably 2.5 to 6 m²/g, especially preferably 3 to 5.5 m²/g, as measured by the BET method when the silver particles contain no resin in the continuous open pores. Generally, when the cumulative 50% particle diameter D50 of the spherical silver particles is increased, the BET specific surface area of the spherical silver particles tends to be decreased. When the cumulative 50% particle diameter D50 of the silver particles is decreased, the BET specific surface area of the spherical silver particles tends to be increased. If silver particles have a D50 of 0.5 to 6 μm and a BET specific surface area of 1 to 8 m²/g, then the silver particles have a large BET specific surface area for a relatively large particle diameter D50 of 0.5 to 6 μm. This means that the (A) silver particles have a large specific surface area relative to the particle diameter and have a multitude of continuous open pores. When (A) silver particles have a BET specific surface area of 1 to 8 m²/g, the silver particles exhibit excellent dispersibility in the silver paste composition, and further can contain a resin in the continuous open pores of the (A) silver particles. The resin contained in the continuous open pores of the (A) silver particles interacts with the resin that is not contained in the continuous open pores to suppress an increase in viscosity and electrical resistivity while maintaining the elastic modulus and strength. Further, the resin contained in the continuous open pores of the (A) silver particles interacts with the resin that is not contained in the continuous open pores to reduce electrical resistivity. The BET specific surface area of (A) silver particles can be measured by, for example, the method used in the below-described Examples.

<Tap Density>

(A) Silver particles that are spherical and have continuous open pores preferably have a tap density of 1 to 6 g/cm³, more preferably 1.5 to 5.5 g/cm³, further preferably 1.8 to 4.5 g/cm³, as measured when the silver particles contain no resin in the continuous open pores. In the present specification, a tap density means the value determined using a tap density measuring apparatus (manufactured by Kuramochi Scientific Instruments Co., Ltd.) by a method in which 10 g of a sample is accurately weighed and placed in a 10 mL settling tube, and subjected to 400-time tapping to determine a tap density. When the silver particles used in the present invention have a tap density of 1 to 6 g/cm³, the particles in a relatively small content can exhibit satisfactory electrical conduction properties in the composition. Further, when the silver particles have a tap density of 1 to 6 g/cm³, the silver paste composition of the present invention suppresses an increase in electrical resistivity. Further, when the silver particles have a tap density of 1 to 6 g/cm³, the silver paste composition of the present invention can reduce electrical resistivity. (A) Silver particles that are spherical and have continuous open pores and that contain no resin in the continuous open pores have a large tap density, as compared to spherical silver particles having the same diameter and having no void therein. On the other hand, silver particles that are spherical and have continuous open pores and that are used in the silver paste composition of the present invention have a structure formed from crystals that have uniformly and densely grown, and therefore have a small tap density, as compared to silver particles having, for example, a dendritic portion that has grown into thin crystal needles. Further, the silver particles that are spherical and have continuous open pores and that are used in the silver paste composition of the present invention have a small tap density, as compared to, for example, flat or flaky silver particles. Here, flat or flaky silver particles refer to silver particles in the form of a plate having two sides as observed with a scanning electron microscope (SEM). The flat or flaky silver particles are those for which [average thicknesses of the silver particles]:[average major axis of the silver particles], which is the ratio (aspect ratio) of the average major axis of the silver particles to the average thickness of the silver particles, when determined by observing 50 particles, is 1:1.1 or more.

<K Value>

With respect to (A) silver particles that are spherical and have continuous open pores, it is preferred that the value K satisfy 3≦K≦72, where the value K is expressed by the equation (2) below, which is calculated from the specific surface area SS of the (A) silver particles expressed by the equation (1) below and the BET specific surface area BS of the (A) silver particles. The value K expressed by the general expression (2) below more preferably satisfies the relationship: 3 K 60, further preferably satisfies the relationship: 3 K 40, especially preferably satisfies the relationship: 3≦K≦15.

SS=6/ρd (1)
wherein ρ represents the theoretical density of (A) silver particles that contain no resin in the continuous open pores, and d represents the volume-based cumulative 50% particle diameter D50, as measured by a particle size distribution measurement method based on image analysis.

K=SS/BS×100 (2)
wherein SS is the specific surface area of (A) silver particles expressed by equation (1), and BS is the specific surface area of (A) silver particles, as measured by the BET method.

With respect to the silver paste composition of the present invention, when the value K, expressed by the equation (2) above, satisfies the relationship: 3≦K≦72, the silver paste composition containing (A) silver particles and a (B) resin and/or (C) dispersant can contain appropriate amounts of the (B) resin and/or (C) dispersant in the continuous open pores of the (A) silver particles. With respect to the silver paste composition of the present invention, it is preferred that the value K expressed by the equation (2) above satisfy the relationship: 3≦K≦72, because the (B) resin and/or (C) dispersant contained in the continuous open pores of the (A) silver particles and the (B) resin and/or (C) dispersant present outside the (A) silver particles can act to prevent the (A) silver particles from becoming poor in dispersibility.

<SA Value>

With respect to (A) silver particles that are spherical and have continuous open pores, when no resin is contained in the continuous open pores, SA preferably satisfies the relationship: 20≦SA≦40, wherein the area SA of void portions is obtained by subjecting an image of the cross-section of the silver particles taken with a scanning electron microscope (SEM) at a magnification of 20,000 times to image analysis processing using a specific piece of image analysis software. The area of void portions was determined by a method in which (A) silver particles containing no resin in the continuous open pores were subjected to ion milling using an argon ion milling machine (manufactured by Hitachi High-Technologies Corporation; trade name: E-3500) under conditions such that the beam diameter at half maximum was 400 μm and the ion gun was set to 6 kV (accelerating voltage: 6 kV; discharge voltage: 4 kV; discharge current: 400 μA; irradiation current: 100 μA), and an image of the ion-milled cross-section of the (A) silver particles was taken with a scanning electron microscope (SEM) at a magnification of 20,000 times, and the information in the image file of the cross-section of the (A) silver particles was subjected to image analysis using image analysis software (developed by Mitani Corporation; trade name: “WinROOF”) to calculate the area of all the void portions present in the cross-section of the (A) silver particles. The area SA of void portions was determined as the average of the areas of void portions in 50 (A) silver particles.

[(B) Resin]

The silver paste composition of the present invention comprises a (B) resin. The mass ratio (A:B) of the (A) silver particles to the (B) resin contained in the silver paste composition is preferably 30:70 to 99:1, more preferably 50:50 to 99:1, further preferably 60:40 to 99:1. When the mass ratio (A:B) of the (A) silver particles to the (B) resin in the silver paste composition is 30:70 to 99:1, the (A) silver particles can contain an appropriate amount of the (B) resin in the continuous open pores thereof without sacrificing the dispersibility and electrical conductivity of the (A) silver particles. Further, when the mass ratio (A:B) of the (A) silver particles to the (B) resin in the silver paste composition is 30:70 to 99:1, the (B) resin contained in the continuous open pores of the (A) silver particles interacts with the (B) resin that is not contained in the continuous open pores, so that the (B) resin fuses at a relatively low temperature (for example, at 120 to 200° C.). Therefore, the silver paste composition of the present invention can produce a conductor in the form of a thin film having a uniform thickness of about 25 μm and having low electrical resistivity and excellent electrical conductivity.

With respect to the (B) resin contained in the silver paste composition, there is no particular limitation as long as it is a resin generally used in a wiring circuit for an electronic device and others or a conductive material, such as a conductive bonding agent. Specifically, any resin may be used as the (B) resin as long as it functions as a binder, and is preferably at least one resin selected from among a thermoplastic resin and a thermosetting resin. The thermoplastic resin in component (B) is preferably at least one resin selected from the group consisting of a polystyrene resin, an acrylic resin, a polycarbonate resin, a polyamide resin, a polyamide-imide resin, and a liquid thermoplastic elastomer having a glass transition temperature of 25° C. or lower and being in a liquid state or being dissolved in an organic solvent. As a thermoplastic resin, a cellulose derivative, such as methyl cellulose or ethyl cellulose, may be used. The thermosetting resin in component (B) is preferably at least one resin selected from the group consisting of an epoxy resin, a cyanate (cyanic acid ester) resin, a urethane resin, and an unsaturated polyester resin. These resins may be used individually or in combination.

With respect to polystyrene resins, there is no particular limitation, and examples include polymers obtained by polymerizing an aromatic vinyl compound, such as styrene, o-methylstyrene, p-methylstyrene, p-tert-butylstyrene, 1,3-dimethylstyrene, a-methylstyrene, vinylnaphthalene, vinylanthracene, and 1,1-diphenylethylene. The polystyrene resin may be either a polymer obtained by polymerizing only an aromatic vinyl compound or a copolymer obtained by copolymerizing an aromatic vinyl compound with another monomer.

With respect to acrylic resins, there is no particular limitation, and examples include polymers obtained by polymerizing at least one monomer selected from among acrylic acid, methacrylic acid, an acrylate, and a methacrylate. A preferred acrylic resin is a polymer obtained by polymerizing acrylic acid or methacrylic acid.

With respect to polycarbonate resins, there is no particular limitation, and there can be used a polymer obtained by the phosgene method in which a dihydroxydiaryl compound and phosgene are reacted with each other, or by a transesterification method in which a dihydroxydiaryl compound and a carbonate, such as diphenyl carbonate, are reacted with each other.

With respect to polyamide resins, there is no particular limitation, and polyamide resins refers to polymers having an amide linkage (—NH—CO—) in the principal chain of the polymer, and examples include nylon 6, nylon 66, a copolymer nylon, and a modified nylon, such as N-methoxymethyl nylon.

With respect to polyamide-imide resins, there is no particular limitation, and, for example, there can be mentioned one obtained by mixing tricarboxylic anhydride and a diamine compound or a diisocyanate and subjecting the mixture to polycondensation.

As examples of liquid thermoplastic elastomers having a glass transition temperature of 25° C. or lower and being in a liquid state or being dissolved in an organic solvent, there can be mentioned acrylic rubber, butadiene rubber, silicone rubber, and nitrile rubber. With respect to the thermoplastic elastomers mentioned above, a commercially available product produced by a known method may be used, and examples of such commercially available products include the HycarCTBN series (manufactured by Ube Industries, Ltd.).

When, as a (B) resin contained in the silver paste composition, for example, a liquid thermoplastic elastomer having a glass transition temperature of 25° C. or lower and being in a liquid state or being dissolved in an organic solvent is used, the silver paste composition can be cured under conditions where the thermoplastic elastomer for component (B) is present in the continuous open pores of the (A) silver particles or a small amount of the thermoplastic elastomer for component (B) has flown out of the continuous open pores of the (A) silver particles. Therefore, by curing the (B) resin, the silver paste composition of the present invention can produce a conductor that suppresses an increase in electrical resistivity while maintaining the elastic modulus.

When a liquid thermoplastic elastomer having a glass transition temperature of 25° C. or lower and being in a liquid state or being dissolved in an organic solvent is used as a (B) resin, the content of the thermoplastic elastomer is preferably 1 to 50% by mass, more preferably 2 to 28% by mass, further preferably 3 to 25% by mass, especially preferably 5 to 20% by mass, based on the total mass of the silver paste composition (100% by mass). When the content (incorporated proportion) of the thermoplastic elastomer in the silver paste composition is 1 to 50% by mass, one advantage is that by virtue of the thermoplastic elastomer of component (B) contained in the continuous open pores of the (A) silver particles, there can be obtained a conductor that suppresses an increase in electrical resistivity while maintaining the elastic modulus.

When a thermosetting resin is used as component (B), an epoxy resin or a resol phenolic resin is preferably used. With respect to these resins, even when the (B) resin is added to the silver paste composition in such an amount that the electrical conduction properties are not sacrificed, excellent bonding properties are achieved, and further the heat resistance is excellent. Of these, when a thermosetting resin is used as component (B), a bisphenol A epoxy resin or a bisphenol F epoxy resin is especially preferably used.

When a resin that is liquid at room temperature is used as a (B) resin, it is possible to utilize the resin as a vehicle without using an organic solvent, so that the drying step can be omitted. Examples of such liquid resins include a liquid epoxy resin and a liquid phenolic resin. Examples of liquid epoxy resins include bisphenol A epoxy resins having an average molecular weight of about 400 or less; branched multifunctional bisphenol A epoxy resins, such as p-glycidoxyphenyldimethyltolyl bisphenol A diglycidyl ether; bisphenol F epoxy resins; phenolic novolak epoxy resins having an average molecular weight of about 570 or less; alicyclic epoxy resins comprising as a constituent at least one of vinyl(3,4-cyclohexene)dioxide, (3,4-epoxycyclohexyl)methyl 3,4-epoxycyclohexylcarboxylate, bis(3,4-epoxy-6-methylcyclohexylmethyl) adipate, and 2-(3,4-epoxycyclohexyl)5,1-spiro(3,4-epoxycyclohexyl)-m-dioxane; glycidyl ester epoxy resins comprising as a constituent at least one of diglycidyl hexahydrophthalate, diglycidyl 3-methylhexahydrophthalate, and diglycidyl hexahydroterephthalate; glycidylamine epoxy resins comprising as a constituent at least one of diglycidylaniline, diglycidyltoluidine, triglycidyl-p-aminophenol, tetraglycidyl-m-xylylenediamine, and tetraglycidylbis(aminomethyl)cyclohexane; and hydantoin epoxy resins comprising as a constituent 1,3-diglycidyl-5-methyl-5-ethylhydantoin.

The liquid epoxy resin used as component (B) preferably has a weight average molecular weight (Mw) of 200 to 800 for reasons of compatibility and prevention of evaporation of the raw materials upon heating. The liquid epoxy resin used as component (B) more preferably has a weight average molecular weight (Mw) of 300 to 700, further preferably 350 to 525. The weight average molecular weight (Mw) of the liquid epoxy resin refers to a value measured by gel permeation chromatography (GPC) using the molecular weight conversion calibration obtained with respect to the standard polystyrene. Further, the liquid epoxy resin used as component (B) preferably has an epoxy equivalent (g/eq) of 50 to 500, more preferably 75 to 400, further preferably 85 to 350.

A resin having compatibility with the liquid resin and being in a solid state or exhibiting ultrahigh viscosity at room temperature may be mixed into the liquid resin in such an amount that the resultant mixture exhibits fluidity. Examples of the resins further mixed into the liquid resin include epoxy resins, such as a high molecular-weight bisphenol A epoxy resin, diglycidylbiphenyl, a novolak epoxy resin, and a tetrabromobisphenol A epoxy resin; and novolak phenolic resins.

When an epoxy resin is used as a (B) resin, a self-curing epoxy resin may be used. With respect to the epoxy resin used as a (B) resin, a curing agent, such as an amine, an acid anhydride, or an onium salt, or a curing accelerator may be used. With respect to the epoxy resin used as a (B) resin, an amino resin or a phenolic resin may be used as a curing agent for the epoxy resin.

With respect to the cyanate (cyanic acid ester) resin, there is no particular limitation, and the cyanate resin may be a resin having an —NCO group in the molecule thereof. Examples of cyanate (cyanic acid ester) resins include cyanates obtained by a reaction of, for example, 1,3-dicyanatobenzene, 1,4-dicyanatobenzene, 1,3,5-tricyanatobenzene, 1,3-dicyanatonaphthalene, 1,4-dicyanatonaphthalene, 1,6-dicyanatonaphthalene, 1,8-dicyanatonaphthalene, 2,6-dicyanatonaphthalene, 2,7-dicyanatonaphthalene, 1,3,6-tricyanatonaphthalene, 4,4′-dicyanatobiphenyl, bis(4-cyanatophenyl)methane, bis(3,5-dimethyl-4-cyanatophenyl)methane, 2,2-bis(4-cyanatophenyl)propane, 2,2-bis(3,5-dibromo-4-cyanatophenyl)propane, bis(4-cyanatophenyl) ether, bis(4-cyanatophenyl)thioether, bis(4-cyanatophenyl) sulfone, tris(4-cyanatophenyl)phosphite, tris(4-cyanatophenyl)phosphate, and a novolak resin and a cyanogen halide.

Examples of urethane resins include polyurethane resins derived from at least one of a polyhydroxy compound (for example, ethylene glycol, propylene glycol, glycerol, or trimethylolpropane), an aliphatic polyester polyol obtained by a reaction of a polyhydroxy compound and a polybasic acid, a polyether polyol (for example, poly(oxypropylene ether)polyol or poly(oxyethylene-propylene ether)polyol), a polycarbonate polyol, and a polyethylene terephthalate polyol, and a polyisocyanate.

With respect to unsaturated polyester resins, there is no particular limitation, but, for example, there can be mentioned various unsaturated polyester resins having radical polymerizability that are prepared by subjecting a polybasic acid, such as phthalic anhydride or maleic anhydride, and a polyhydric alcohol, such as glycol, to a polycondensation reaction to form an unsaturated alkyd, and, if necessary, further mixing the unsaturated alkyd with a radically polymerizable vinyl monomer, such as styrene.

[(C) Dispersant]

The silver paste composition of the present invention may comprise a (C) dispersant. With respect to the dispersant for component (C), a known dispersant for (A) silver particles can be used. Examples of (C) dispersants include fatty acids, such as stearic acid and oleic acid; fatty acid salts, such as sodium stearate and potassium oleate; surfactants, such as an alkylbenzenesulfonate and an aliphatic quaternary ammonium; organometals, such as magnesium citrate and diethylzinc; chelating agents, such as imidazole and oxazole; and protective colloids, such as gelatin and albumin. As the (C) dispersant contained in the silver paste composition, preferred is at least one dispersant selected from the group consisting of a fatty acid or a salt thereof, a surfactant, an organometal, and a protective colloid.

With respect to the silver paste composition, (A) silver particles and a (C) dispersant are mixed with each other, in the presence of a solvent if necessary, so that the (C) dispersant is contained in the continuous open pores of the (A) silver particles, treating the surfaces of the (A) silver particles with the (C) dispersant. Then, the silver paste composition may be produced by mixing the (A) silver particles having the (C) dispersant contained in the continuous open pores of the (A) silver particles and having the surfaces treated with the (C) dispersant with other components. The silver paste composition may be produced by mixing (A) silver particles, a (B) resin, and a (C) dispersant with other components.

With respect to the silver paste composition comprising (A) silver particles having a (C) dispersant contained in the continuous open pores of the (A) silver particles and having the surfaces treated with the (C) dispersant, when mixing another component (for example, a (B) resin), aggregation of the (A) silver particles is suppressed by the (C) dispersant. Therefore, by curing, for example, a (B) resin in the silver paste composition, the silver paste composition can form, for example, a conductor in the form of a uniform and dense thin film having a thickness of 25 μm or less and having low electrical resistivity.

The content (incorporated proportion) of a (C) dispersant in the silver paste composition is affected by the content (incorporated proportion) of a (B) resin, which is another component, but is preferably 0.01 to 20% by mass, based on the total mass of the (A) silver particles and the (C) dispersant (100% by mass). The content (incorporated proportion) of a (C) dispersant in the silver paste composition is more preferably 0.01 to 10% by mass, further preferably 0.01 to 5% by mass, based on the total mass of the (A) silver particles and the (C) dispersant (100% by mass). When the content (incorporated proportion) of a (C) dispersant in the silver paste composition is 0.01 to 20% by mass, based on the total mass of the (A) silver particles and the (C) dispersant (100% by mass), by virtue of the (C) dispersant contained in the continuous open pores of the (A) silver particles and/or the (C) dispersant present on the surfaces of the (A) silver particles, the (A) silver particles and other components including a (13) resin can be uniformly mixed with each other without causing the (A) silver particles to suffer aggregation. Further, when the content (incorporated proportion) of a (C) dispersant in the silver paste composition is 0.01 to 20% by mass, based on the total mass of the (A) silver particles and the (C) dispersant (100% by mass), by curing the silver paste composition, a conductor in the form of a uniform and dense thin film having low electrical resistivity can be formed.

[(D) Curing Agent]

It is preferred that the silver paste composition of the present invention further comprise a (D) curing agent.

With respect to the curing agent for component (D), a known curing agent for an epoxy resin can be used. As examples of curing agents for component (D), there can be mentioned at least one curing agent selected from the group consisting of a phenolic curing agent, such as a phenolic resin, an amine curing agent, an imidazole curing agent, and an acid anhydride curing agent. Examples of phenolic curing agents for component (D) include phenolic resins. As a phenolic resin, any monomer, oligomer, and polymer having two or more phenolic hydroxyl groups capable of reacting with an epoxy resin can be used. Examples of phenolic resins include a resol phenolic resin, a phenolic novolak resin, a cresol novolak resin, a bisphenol A novolak resin, and a triazine-modified phenolic novolak resin.

Examples of amine curing agents include chain aliphatic amines, cyclic aliphatic amines, aliphatic aromatic amines, and aromatic amines. Specific examples of amine curing agents for component (D) include triazine compounds, such as 2,4-diamino-6-[2′-methylimidazolyl-(1′)]ethyl-s-triazine, and tertiary amine compounds, such as 1,8-diazabicyclo[5.4.0]undecene-7 (DBU), triethylenediamine, benzyldimethylamine, and triethanolamine.

Examples of imidazole curing agents include imidazole curing agents, such as 2-methylimidazole, 2-ethyl-4-methylimidazole, 2-undecylimidazole, 2-heptadecylimidazole, 2-phenylimidazole, 1-benzyl-2-methylimidazole, 1-cyanoethyl-2-methylimidazole, 1-cyanoethyl-2-ethyl-4-methylimidazole, and 1-cyanoethyl-2-undecylimidazole.

Examples of acid anhydride curing agents include phthalic anhydride, maleic anhydride, dodecenyl succinic anhydride, trimellitic anhydride, benzophenonetetracarboxylic dianhydride, tetrahydrophthalic anhydride, methyltetrahydrophthalic anhydride, methylbutenyltetrahydrophthalic anhydride, and hexahydrophthalic anhydride.

As a (D) curing agent, at least one member selected from the group consisting of a phenolic curing agent, an amine curing agent, and an acid anhydride curing agent may be used. Two or more members selected from the above group may be used in combination.

When an epoxy resin is used as a (B) resin, the effective amount of the (D) curing agent varies depending on the type of epoxy resin and the type of (D) curing agent. When the (D) curing agent is a phenolic curing agent, an effective amount of the (D) curing agent is such that the ratio of the hydroxyl equivalent (g/eq) of the phenolic curing agent to the epoxy equivalent (g/eq) of the epoxy resin (hydroxyl equivalent/epoxy equivalent) is preferably 0.01 to 5, more preferably 0.04 to 1.5, further preferably 0.06 to 1.2.

When the (D) curing agent is an amine curing agent, an effective amount of the (D) curing agent is such that the ratio of the amine value (mg KOH/g) of the amine curing agent to the epoxy equivalent (g/eq) of the epoxy resin (amine value/epoxy equivalent) is preferably 0.001 to 3 (mg KOH/g), more preferably 0.01 to 2 (mg KOH/g), further preferably 0.05 to 1.5 (mg KOH/g). The amine value refers to the amount in mg of potassium hydroxide that is in the same moles as the amount of hydrochloric acid required for neutralizing 1 g of an amine curing agent in terms of solids content.

When the (D) curing agent is an imidazole curing agent, with respect to the content (incorporated proportion) of the (D) curing agent, the amount of the imidazole curing agent is, relative to 100 parts by mass of the epoxy resin, preferably 0.1 to 50 parts by mass, more preferably 0.25 to 30 parts by mass, further preferably 0.5 to 20 parts by mass.

When the (D) curing agent is an acid anhydride curing agent, an effective amount of the (D) curing agent is such that the ratio of the acid anhydride equivalent (g/eq) of the curing agent to the epoxy equivalent (g/eq) of the epoxy resin (acid anhydride equivalent/epoxy equivalent) is preferably 0.05 to 10, more preferably 0.1 to 5, further preferably 0.5 to 3.

When two or more members from a phenolic curing agent, amine curing agent, imidazole curing agent, and acid anhydride curing agent are used in combination, the curing agents may be added in the above-mentioned respective amounts.

In the method for producing a silver paste composition, (A) silver particles and a (D) curing agent are mixed with each other, in the presence of a solvent if necessary, so that the (D) curing agent is contained in the continuous open pores of the (A) silver particles. Then, the (A) silver particles having a (D) curing agent contained in the continuous open pores thereof and other components are mixed with each other to produce the silver paste composition. Alternatively, the silver paste composition may be produced by mixing (A) silver particles, a (B) resin, and a (D) curing agent with other components.

[(E) Fluxing Agent]

The silver paste composition of the present invention may further comprise a (E) fluxing agent. The fluxing agent for component (E) is preferably at least one fluxing agent selected from the group consisting of a rosin fluxing agent, a modified rosin fluxing agent, and an organic acid fluxing agent. Examples of rosin fluxing agents include natural rosin, polymerized rosin, and hydrogenated rosin. Examples of modified rosin fluxing agents include an acid-modified rosin fluxing agent. Examples of organic acid fluxing agents include abietic acid, adipic acid, ascorbic acids, citric acid, 2-furancarboxylic acid, malic acid, valeric acid, lauric acid, stearic acid, and isostearic acid.

With respect to the silver paste composition, (A) silver particles and a (E) fluxing agent are mixed with each other, in the presence of a solvent if necessary, so that the (E) fluxing agent is contained in the continuous open pores of the (A) silver particles. Then, the (A) silver particles having the (E) fluxing agent contained in the continuous open pores thereof and other components are mixed with each other to produce the silver paste composition. Alternatively, the silver paste composition may be produced by mixing (A) silver particles, a (B) resin, and (E) fluxing agent with other components.

In the silver paste composition comprising (A) silver particles having a (E) fluxing agent contained in the continuous open pores thereof and other components (for example, a (B) resin), in curing the silver paste composition, the (E) fluxing agent in the continuous open pores of the (A) silver particles acts to promote the melting of the (A) silver particles. The silver paste composition containing (A) silver particles having a (E) fluxing agent contained in the continuous open pores thereof can form a conductor in the form of a uniform and dense thin film having, for example, a thickness of 25 μm or less and having low electrical resistivity.

The content (incorporated proportion) of a (E) fluxing agent in the silver paste composition is affected by the content (incorporated proportion) of the (B) resin. The content (incorporated proportion) of the (E) fluxing agent in the silver paste composition is preferably 0.1 to 20 parts by mass, relative to 100 parts by mass of the total of the (A) silver particles and (E) fluxing agent. The content (incorporated proportion) of the (E) fluxing agent in the silver paste composition is more preferably 0.5 to 18 parts by mass, further preferably 0.75 to 15 parts by mass, especially preferably 5 to 12% by mass. When the proportion of a (E) fluxing agent incorporated into the silver paste composition is 0.1 to 20 parts by mass, by virtue of the (E) fluxing agent contained in the continuous open pores of the (A) silver particles, for example, the electrical resistivity of the obtained conductor can be reduced.

[(F) Curing Accelerator]

The silver paste composition of the present invention may further comprise a (F) curing accelerator. When an epoxy resin is used as component (B), a known curing accelerator for the epoxy resin can be used as the curing accelerator for component (F). Examples of (F) curing accelerators include heterocyclic imidazole compounds, such as 2-methylimidazole and 2-ethyl-4-methylimidazole; phosphorus compounds, such as triphenylphosphine and tetraphenylphosphonium tetraphenylborate; tertiary amines, such as 2,4,6-tris(dimethylaminomethyl)phenol and benzyldimethylamine; BBUs, such as 1,8-diazabicyclo(5,4,0)undecene or a salt thereof; amines; and adduct accelerators obtained by adducting to an imidazole, epoxy, urea, an acid, or the like. The imidazole curing agent for component (D) and the imidazole for component (F) may be the same or different.

With respect to the silver paste composition, (A) silver particles and a (F) curing accelerator are mixed with each other, in the presence of a solvent if necessary, so that the (F) curing accelerator is contained in the continuous open pores of the (A) silver particles. Then, the (A) silver particles having a (F) curing accelerator contained in the continuous open pores thereof and other components including a resin for component (B) are mixed with each other to produce a silver paste composition. The silver paste composition may be produced by mixing (A) silver particles, a (B) resin, and (F) curing accelerator with other components.

In the silver paste composition comprising (A) silver particles having a (F) curing accelerator contained in the continuous open pores thereof and other components (for example, a (B) resin), in curing the silver paste composition, the (F) curing accelerator gradually flows out of the continuous open pores of the (A) silver particles into the (B) resin, thereby suppressing an increase in the viscosity of the silver paste composition. Therefore, the silver paste composition containing (A) silver particles having a (F) curing accelerator contained in the continuous open pores thereof can form a conductor that suppresses an increase in electrical resistivity.

The content (incorporated proportion) of a (F) curing accelerator in the silver paste composition is also affected by the content (incorporated proportion) of the (B) resin. The content (incorporated proportion) of the (F) curing accelerator in the silver paste composition is preferably 1 to 10% by mass, more preferably 2 to 8% by mass, further preferably 3 to 6% by mass, based on the total mass of the (A) silver particles and (F) curing accelerator (100% by mass). When the content (incorporated proportion) of a (F) curing accelerator in the silver paste composition is 1 to 10% by mass, an increase in the viscosity of the silver paste composition due to the (F) curing accelerator contained in the continuous open pores of the (A) silver particles can be suppressed. The silver paste composition having a (F) curing accelerator contained in the continuous open pores of the (A) silver particles can form a conductor that suppresses an increase in electrical resistivity. When the imidazole curing agent for component (D) and the imidazole used as component (F) are the same, there are no restrictions on the proportions of component (D) and component (F) incorporated into the silver paste composition, as long as the proportions are in the above-mentioned respective ranges of the proportions of component (D) and component (F).

With respect to the silver paste composition, first, (A) silver particles and at least one member selected from among a (B) resin, a (C) dispersant, a (D) curing agent, a (E) fluxing agent, and a (F) curing accelerator are mixed with each other. Then, (A) silver particles having at least one substance contained in the continuous open pores of the (A) silver particles as described above are formed, and then the resultant (A) silver particles and other components are mixed with each other, producing the silver paste composition. The member or members selected from among a (B) resin, a (C) dispersant, a (D) curing agent, a (E) fluxing agent, and a (F) curing agent contained in the continuous open pores of the (A) silver particles may be a single member used singly or two or more members used in combination.

The silver paste composition of the present invention comprises (A) silver particles that are spherical and have continuous open pores, and a (B) resin and/or (C) dispersant, and optionally further at least one member selected from among a (D) curing agent, a (E) fluxing agent, and a (F) curing accelerator, and may further comprise an additive, such as a solvent, a silane coupling agent, an inorganic and/or organic pigment, a leveling agent, a thixotropic agent, or an anti-foaming agent. Substances to be contained in the silver paste composition other than components (B) to (F) can be appropriately selected depending on the type of (B) resin or the type of at least one member selected from among a (C) dispersant, a (D) curing agent, a (E) fluxing agent, and a (F) curing accelerator.

In the silver paste composition of the present invention, the amount of the substance contained in the continuous open pores of the (A) silver particles is preferably 1 to 50% by mass, more preferably 2 to 40% by mass, further preferably 5 to 30% by mass, especially preferably 8 to 25% by mass, based on the total mass of the (A) silver particles and the substance contained. When a plurality of substances are contained in the continuous open pores of the (A) silver particles, the term “amount of the substance contained” refers to a total of the amounts of the plurality of substances contained.

Next, a method for producing the silver paste composition of the present invention is described.

The method for producing the silver paste composition of the present invention comprises the steps of: adding a silver salt and a polycarboxylic acid to a liquid phase to obtain an aqueous solution containing silver ions; then adding a reducing agent to the obtained aqueous solution to cause, in the liquid phase, precipitation of silver particles that have continuous open pores; and mixing the obtained (A) silver particles that have continuous open pores, and a (B) resin with each other.

[Step of Obtaining an Aqueous Solution Containing Silver Ions]

A silver salt and a polycarboxylic acid are first added to a liquid phase to obtain an aqueous solution containing silver ions.

The silver salt is preferably at least one silver salt selected from the group consisting of silver nitrate, silver sulfate, silver carbonate, and silver chloride.

The silver salt may be added directly to the liquid phase to which a polycarboxylic acid is added. However, it is preferred that the silver salt be mixed in the form of an aqueous solution preferably in pure water or ion-exchanged water with a polycarboxylic acid or an aqueous solution containing a polycarboxylic acid. The concentration of the aqueous silver salt solution to be added to the liquid phase is preferably 3 to 20 mol %/L, more preferably 5 to 15 mol %/L, further preferably 8 to 12 mol %/L.

With respect to polycarboxylic acids, there is no particular limitation. Examples of polycarboxylic acids include aliphatic polycarboxylic acids, such as a dicarboxylic acid and an oxypolycarboxylic acid. Examples of dicarboxylic acids include malonic acid, succinic acid, maleic acid, and fumaric acid. Examples of oxypolycarboxylic acids include oxydicarboxylic acids, such as tartaric acid and malic acid, and oxytricarboxylic acids, such as citric acid. Of these, the polycarboxylic acid used is preferably at least one polycarboxylic acid selected from the group consisting of citric acid, malic acid, maleic acid, and malonic acid. The polycarboxylic acid is more preferably citric acid, malic acid, or maleic acid. Polycarboxylic acids may be used individually or in combination.

The polycarboxylic acid may be added directly to the liquid phase to which a silver salt is added. It is preferred that the polycarboxylic acid be added to pure water or ion-exchanged water to form an aqueous solution, and the aqueous solution containing the polycarboxylic acid be mixed with a silver salt, or the aqueous solution containing the polycarboxylic acid be mixed with an aqueous solution containing a silver salt. The concentration of the aqueous polycarboxylic acid solution is preferably 0.7 to 40 mol %/L, more preferably 0.8 to 30 mol %/L, further preferably 1 to 20 mol %/L, especially preferably 2 to 15 mol %/L.

The liquid phase in which the silver salt and polycarboxylic acid are mixed is a liquid in which both the silver salt and the polycarboxylic acid are soluble, and is preferably pure water or ion-exchanged water.

The temperature for the step of mixing a silver salt and a polycarboxylic acid in a liquid phase is preferably 10 to 35° C., more preferably 15 to 25° C. A silver salt and a polycarboxylic acid may be mixed in a liquid phase for such a period of time that the silver salt and polycarboxylic acid can be uniformly mixed with each other to obtain an aqueous solution containing silver ions, and the reaction time is not particularly limited, but is preferably about 1 minute to 1 hour, more preferably about 5 to 40 minutes.

[Step of Causing Precipitation of Silver Particles]

Then, a reducing agent is added to the aqueous solution containing silver ions to cause precipitation of silver particles that are spherical and have continuous open pores. Examples of reducing agents include ascorbic acid, and the term “ascorbic acid” includes isomers, such as D-ascorbic acid, L-ascorbic acid, and isoascorbic acid. Ascorbic acids may be used individually or in combination.

The reducing agent may be added directly to the aqueous solution containing silver ions. However, it is preferred that the reducing agent be added in the form of an aqueous solution preferably in pure water or ion-exchanged water to the aqueous solution containing silver ions. The concentration of the aqueous reducing agent solution is preferably 1 to 10 mol %/L, more preferably 2 to 8 mol %/L, further preferably 3 to 7 mol %/L, especially preferably 4 to 6 mol %/L.

The temperature for the step of adding a reducing agent to cause precipitation of silver ions is preferably 10 to 35° C., more preferably 15 to 25° C. There is no particular limitation as to the period of time over which the reducing agent is added. The reducing agent is preferably added all at once while stirring the mixture obtained by mixing the silver salt and polycarboxylic acid in the liquid phase. There is no particular limitation either as to the period of time over which the mixture is stirred after the reducing agent is added. With respect to the period of time over which the mixture is stirred after the reducing agent is added, it is preferred that the stirring be continued for about 3 minutes to 1 hour after the foaming phenomenon accompanying the reduction reaction ceases. When the stirring is stopped and the mixture is allowed to stand, the precipitate of silver particles settles.

In the step of causing precipitation of silver particles, an additive, such as a dispersant, may be added to the aqueous solution containing silver ions, if necessary. A dispersant can prevent the precipitate of silver particles from suffering aggregation, so that the precipitate of silver particles can be kept in an excellent dispersed state. Examples of dispersants include cationic dispersants, such as a higher alkylmonoamine salt, an alkyldiamine salt, and a quaternary ammonium salt; anionic dispersants, such as a carboxylic acid salt, a sulfate salt, and a phosphate salt; and fatty acids, such as lauric acid, stearic acid, and oleic acid. An additive, such as a dispersant, added if necessary in the step of causing precipitation of silver particles is not limited to the above-mentioned examples.

The precipitate of silver particles is preferably collected by filtration and then dried. With respect to the temperature for drying, there is no particular limitation, but the drying temperature is preferably 0 to 80° C., more preferably 10 to 60° C. The period of time for drying varies depending on the drying temperature, and is not particularly limited. The drying time is preferably 1 to 20 hours, more preferably 3 to 18 hours.

The ratio between the incorporated silver salt, polycarboxylic acid, and reducing agent (in terms of solids content) (silver salt:polycarboxylic acid:reducing agent) is preferably, in terms of molar ratio, 1:0.1 to 0.5:0.5 to 1, more preferably 1:0.2 to 0.45:0.6 to 0.9, further preferably 1:0.3 to 0.4:0.7 to 0.85.

The silver particles produced by the above-mentioned method are particles that are spherical and have continuous open pores and that are formed through crystal growth from the center outwardly, in a uniform radial pattern, into a dendrite. The silver particles have a finely uneven structure on the spherical surface thereof, and the ends of branches of the grown crystal dendrites are not interlocked with one another. Therefore, the silver particles are unlikely to suffer aggregation, and further are in a state such that adjacent silver particles are easily separated from each other, and hence exhibit excellent dispersibility.

[Mixing (A) Silver Particles with a (B) Resin]

Then, (A) silver particles that are spherical and have continuous open pores and a (B) resin are mixed with each other. (A) Silver particles, a (B) resin, and other components can be mixed with each other using a mixing machine, such as a planetary stirring machine, a dissolver, a bead mill, a Raikai mixer, a three-roll mill, a rotary mixer, or a two-shaft mixer. Thus, a silver paste composition having an apparent viscosity suitable for screen printing, immersion, or other desired methods for forming a coating film can be produced.

The obtained silver paste composition can be applied to a substrate made of, for example, polyethylene terephthalate (PET) or indium tin oxide (ITO) by such methods as printing and coating to form a coating film, and the resultant coating film can be cured by heating to obtain a conductor comprising a cured product. The temperature for heating the silver paste composition varies depending on, for example, the type of resin contained in the silver paste composition and is not particularly limited, but the silver paste composition is heated preferably at 80 to 200° C., more preferably 100 to 180° C.

In the silver paste composition of the present invention, by using (A) silver particles that are spherical and have continuous open pores, a (B) resin, for example, can be contained in the continuous open pores of the (A) silver particles. When the substance contained in the continuous open pores of the (A) silver particles is a (B) resin, in curing the silver paste composition, the (B) resin gradually flows out of the continuous open pores of the (A) silver particles and interacts with the resin outside the (A) silver particles, so that the resin fuses at a relatively low temperature (for example, at 120 to 200° C.). Therefore, the silver paste composition can form a conductor in the form of a thin film having a uniform thickness of about 25 μm and having excellent electrical conduction properties such that the electrical resistivity is low.

[Mixing (A) Silver Particles with Other Components]

When (A) silver particles that are spherical and have continuous open pores are mixed with another component, the component is incorporated into the continuous open pores of the silver particles. By mixing the resultant (A) silver particles having the component contained in the continuous open pores thereof with, for example, a (B) resin, an increase in viscosity or an increase in electrical resistivity can be suppressed. Therefore, the silver paste composition containing (A) silver particles that are spherical and have continuous open pores provides excellent properties as a conductive material that can reduce electrical resistivity.

With respect to the order of mixing (A) silver particles, a (B) resin, and other components, there is no particular limitation. In the silver paste composition, (A) silver particles, a (B) resin, and other components may be mixed together at the same time. In the silver paste composition, (A) silver particles and a (B) resin may be mixed with each other first, and then mixed with other components. (A) Silver particles, a (B) resin, and other components of the silver paste composition can be mixed with each other using a mixing machine, such as a planetary stirring machine, a dissolver, a bead mill, a Raikai mixer, a three-roll mill, a rotary mixer, or a two-shaft mixer.

In the silver paste composition, when the substance contained in the continuous open pores of the (A) silver particles is, for example, a thermoplastic elastomer as a (B) resin, the silver paste composition can be cured in a state such that the thermoplastic elastomer is present in the continuous open pores of the silver particles or that a small amount of the thermoplastic elastomer flows out of the continuous open pores of the silver particles in curing the silver paste composition. When the silver paste composition comprises (A) silver particles and a thermoplastic elastomer as a (B) resin contained in the continuous open pores of the (A) silver particles, the silver paste composition can form a conductor that suppresses an increase in electrical resistivity while maintaining the elastic modulus.

In the silver paste composition, when the substance contained in the continuous open pores of the (A) silver particles is a (C) dispersant, the (A) silver particles can be mixed with other components to obtain a silver paste composition that is uniformly dispersed without suffering aggregation. The silver paste composition can form a conductor in the form of a uniform and dense thin film having a thickness of 25 μm or less and having low electrical resistivity, for example.

In the silver paste composition, when the substance contained in the continuous open pores of the (A) silver particles is a (D) curing agent, in curing the silver paste composition, the (D) curing agent gradually flows out of the continuous open pores of the (A) silver particles into the (B) resin, thereby suppressing an increase in the viscosity of the silver paste composition.

In the silver paste composition, when the substance contained in the continuous open pores of the (A) silver particles is a (E) fluxing agent, in curing the silver paste composition, the (E) fluxing agent in the continuous open pores of the (A) silver particles acts to promote the melting of the (A) silver particles. The silver paste composition can form a conductor in the form of a thin film having a thickness of 25 μm or less, for example. The silver paste composition can form a conductor in the form of a uniform and dense film having low electrical resistivity.

In the silver paste composition, when the substance contained in the continuous open pores of the (A) silver particles is a (F) curing accelerator, in curing the silver paste composition, the (F) curing accelerator gradually flows out of the continuous open pores of the (A) silver particles into the (B) resin. The silver paste composition can suppress an increase in viscosity, and further can suppress an increase in electrical resistivity, thus forming a conductor.

The silver paste composition of the present invention can effectively form a conductor, such as an electronic circuit or an electrode, in particular a patterned conductor on the surface of a substrate. Further, the silver paste composition of the present invention can be advantageously used as a conductive paste for a plating undercoat, a resistor, or an electrode, a semiconductor encapsulation agent, or a conductive bonding agent, such as a die attach adhesive.

A conductor comprising a cured product obtained by curing the silver paste composition of the present invention can be advantageously used as an electronic part for, for example, a chip capacitor, an end face base electrode of a chip resistor, a variable resistor, or a film substrate circuit.

### EXAMPLES

In the following, the present invention will be described in more detail using Examples. The present invention should not be construed as limited to these Examples.

[Production of Silver Particles a]

Silver particles a, which are spherical and have continuous open pores, were produced as follows.

(Step of Obtaining an Aqueous Solution Containing Silver Ions)

10 kg of an aqueous silver nitrate solution (concentration: 10 mol %/L), 4 kg of an aqueous citric acid solution (concentration: 10 mol %/L), and 20 kg of pure water at 25° C. were individually weighed, and then placed in a 50-liter (L) stainless steel tank. Then, the resultant mixture was stirred at room temperature (25±10° C.) using an agitator (manufactured by Shimazaki Mixing Engineering Co., Ltd.; trade name: JET type AJITER) for 30 minutes to prepare a mixture of silver nitrate and citric acid. Then, 17 kg of an aqueous ascorbic acid solution (aqueous L-ascorbic acid solution; concentration: 5 mol %/L) and 300 kg of pure water at 25° C. were individually weighed. Then, they were placed in a 450-liter stainless steel reaction tank. Then, the resultant mixture was stirred at room temperature (25±10° C.) using an agitator (manufactured by Shimazaki Mixing Engineering Co., Ltd.; trade name: JET type AJITER) for 30 minutes to prepare an aqueous ascorbic acid solution. The ratio between the added silver nitrate, citric acid, and ascorbic acid, in terms of molar ratio (silver nitrate:citric acid:ascorbic acid), was 1:0.4:0.85.

(Step of Causing Precipitation of Silver Particles)

Subsequently, using an agitator having 4 stainless steel blades having a diameter of 600 mm (500 rpm), to the above-prepared aqueous ascorbic acid solution was added the mixture of silver nitrate and citric acid all at once to mix the mixture of silver nitrate and citric acid and the aqueous ascorbic acid solution with each other.

Several seconds after the aqueous ascorbic acid solution was added to the mixture of silver nitrate and citric acid, a reduction reaction started, and after a foaming phenomenon accompanying the reduction reaction ceased, the stirring was continued at 15 to 25° C. for 30 minutes, and then the stirring was stopped. The mixture of silver nitrate, citric acid, and ascorbic acid obtained after the reduction reaction had a pH of 2.

The resultant reaction mixture was allowed to stand, and then the supernatant was removed, and the settled precipitate of silver particles was subjected to filtration using a Nutsche filter, and the collected silver particles A were spread over a stainless steel tray and dried in a dryer maintained at 60° C. for 15 hours. After drying, silver particles having a BET specific surface area of 3.2 m²/g, which is shown in the images of FIGS. 1 to 4 taken by SEM, were obtained.

The obtained silver particles a were subjected to ion milling using an argon ion milling machine (manufactured by Hitachi High-Technologies Corporation; trade name: E-3500) under conditions such that the beam diameter at half maximum was 400 μm and the ion gun as set to 6 kV (accelerating voltage: 6 kV; discharge voltage: 4 kV; discharge current: 400 μA; irradiation current: 100 μA), and an image of the ion-milled cross-section of the silver particles a was taken with a scanning electron microscope (SEM) at a magnification of 20,000 times. The information in the image file of the cross-section of the silver particles a was subjected to image analysis using image analysis software (developed by Mitani Corporation; trade name: “WinROOF”) to calculate the area of all the void portions present in the cross-section of the silver particles a. The area SA of void portions was determined as the average of the areas of void portions in 50 silver particles a. Silver particles a had an SA value of 30 (see FIG. 4).

As shown in FIGS. 1 to 4, silver particles a are spherical and have continuous open pores, and are formed through crystal growth from the center outwardly, in a uniform radial pattern, into a dendrite to form a spherical surface having an uneven structure. In silver particles a, the branches of grown crystal dendrites have no sharp ends and are in the shape of a sphere having a finely uneven structure on the spherical surface thereof, and therefore the silver particles are unlikely to be bonded together or suffer aggregation.

[Production of Silver Particles b]

Spherical silver particles b, which do not have continuous open pores, were produced as follows.

6 Liters of an aqueous silver nitrate solution (concentration: 0.15 mol/L) and 200 ml of aqueous ammonia (concentration: 25 wt %) were mixed together and reacted with each other to give an aqueous solution of a silver amine complex. To the obtained aqueous solution was added 20 g of hydrazine hydrate (concentration: 80 wt %) as a reducing agent to effect reduction, causing precipitation of silver particles b, and the resultant precipitate was subjected to filtration, and washed and dried to obtain a spherical silver powder. The mixture containing a silver amine complex and hydrazine obtained after the reduction reaction had a pH of 2.

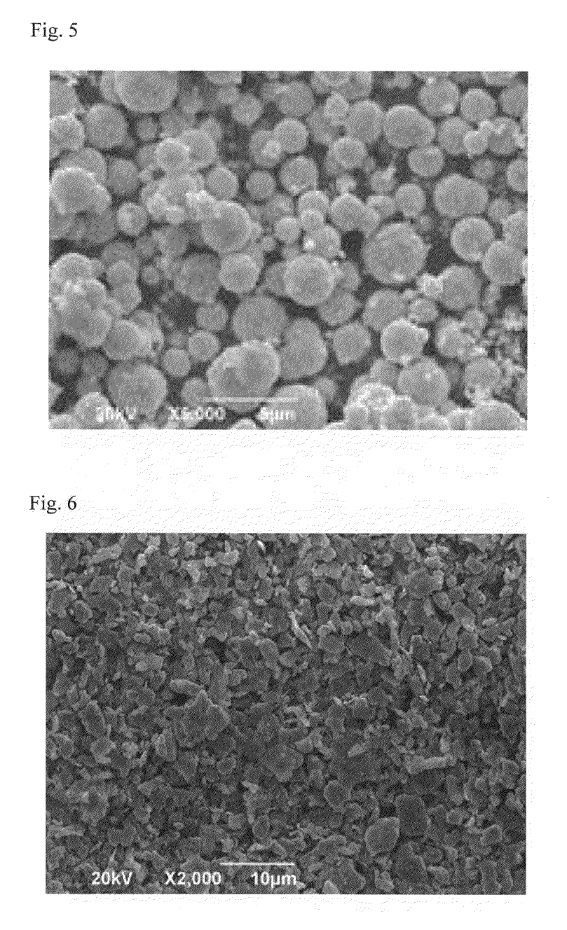

FIG. 5 shows an SEM photomicrograph of silver particles b at a magnification of 5,000 times.

Silver particles b were produced by a conventional method, and the particles were not dendritic but had grown such that the particles became larger by stacking layers on top of each other. As shown in FIG. 5, silver particles b have a dispersion in particle diameter, and the silver particles are likely to be fused together strongly on the surface to cause aggregation of the particles. Silver particles b had not grown into crystal dendrites, and had almost no void in the metal particles, so that it was not possible to measure an SA value.

[Production of Silver Particles c]

Silver particles c in flake form were produced as follows.

To 3,650 g of a silver nitrate solution (silver concentration: 7.7% by mass) was added 166 g of an aqueous formaldehyde solution (formaldehyde concentration: 37% by mass) as a reducing agent, and, while stirring, 710 g of an aqueous ammonia solution (ammonia concentration: 25% by mass) was added to the resultant mixture to form a slurry containing a silver powder. The obtained slurry was subjected to filtration, and washed with water, followed by drying at 75° C. To 107 g of the resultant silver powder was added stearic acid as a dispersant such that the amount of stearic acid was 0.4% by mass, based on the mass of the silver powder, and they were well mixed with each other, and the resultant mixture was placed in a tumbling ball mill, together with 1,107 g of SUS balls (diameter: 1.6 mm), and subjected to flaking treatment under conditions such that the number of revolutions was 116 rpm and the treatment time was 15 hours to obtain a silver powder in flake form.

FIG. 6 shows an SEM photomicrograph of silver particles c at a magnification of 2,000 times.

Silver particles c are in flake form, and have an aspect ratio of 1:10, wherein the aspect ratio is determined by a method in which silver particles c are observed with an SEM and, as shown in FIG. 6, the average diameter of silver particles in the form of a plate having two sides is divided by the average thickness of the silver particles to determine the aspect ratio.

The measurements described below were conducted for silver particles a, silver particles b, and silver particles c. With respect to silver particles A, the following measurements were performed when the particles contained no resin in the continuous open pores. The results are shown in Table 1.

<BET Specific Surface Area>

Measurements were made using a full-automatic specific surface area measurement apparatus Macsoeb (manufactured by MOUNTEC Co., Ltd.). The silver particles were predried at 100° C. and subjected to a nitrogen gas flow for 10 minutes, and then a specific surface area was measured by the BET single-point method using nitrogen gas adsorption.

<Tap Density>

Measurements were made using a tap density measuring apparatus (manufactured by Kuramochi Scientific Instruments Co., Ltd.). 10 g of a sample was accurately weighed and placed in a 10 mL settling tube, and was tapped 400 times at a stroke length of 15 mm, and the density of the resultant sample was taken as the tap density.

<Volume-Based Cumulative 50% Particle Diameter D50, Cumulative 10% Particle Diameter D10, and Cumulative 90% Particle Diameter D90>

Silver particles were observed with a scanning electron microscope (SEM), and individual particles were measured by running the image analysis-based particle size distribution measurement software “Mac-View” Ver. 1, developed by Mountech Co., Ltd., on the information in the files of images of the silver particles taken at a magnification of 20,000 times, and measurements were made for 50 randomly selected silver particles to determine the volume-based cumulative 50% particle diameter D50, cumulative 90% particle diameter D90, and cumulative 10% particle diameter D10

<K Value>

K values were calculated from the specific surface area SS of (A) silver particles expressed by the equation (1) below and the BET specific surface area BS of the (A) silver particles.

SS=6/ρd (1)
wherein ρ represents the theoretical density of the sample (silver particles) containing no resin in the continuous open pores, and d represents the volume-based cumulative 50% particle diameter D50, as measured by a particle size distribution measurement method based on image analysis.

K=SS/BS×100 (2)
wherein SS is the specific surface area of (A) silver particles expressed by equation (1), and BS is the BET specific surface area of the silver particles.

<SA Value>

A sample (silver particles) was subjected to ion milling using an argon ion milling machine (manufactured by Hitachi High-Technologies Corporation; trade name: E-3500) under conditions such that the beam diameter at half maximum was 400 μm and the ion gun was set to 6 kV (accelerating voltage: 6 kV; discharge voltage: 4 kV; discharge current: 400 μA; irradiation current: 100 μA), and an image of the ion-milled cross-section of the sample was taken with a scanning electron microscope (SEM) at a magnification of 20,000 times. The information in the image file of the cross-section of the (A) silver particles was subjected to image analysis using image analysis software (developed by Mitani Corporation; trade name: “WinROOF”) to calculate the area of all the void portions present in the cross-section of the sample. The average area of void portions of 50 particles in the sample was taken to be the area SA of void portions.

TABLE 1

| | Silver | Silver | Silver |
|---|---|---|---|
| | particles a | particles b | particles c |
| Specific surface area (m²/g) | 3.2 | 0.4 | 1.0 |
| Tap density (g/cm³) | 2.82 | 3.39 | 4.8 |
| Volume-based cumulative 50% | 3.32 | 7.1 | 1.0 |
| particle diameter D50 (μm) | | | |
| Volume-based cumulative 90% | 4.29 | 15.09 | 3.6 |
| particle diameter D90 (μm) | | | |
| Volume-based cumulative 10% | 2.33 | 2.99 | 8.7 |
| particle diameter D10 (μm) | | | |
| Particle size distribution (D90/D50) | 1.29 | 2.13 | 2.42 |
| Particle size distribution (D50/D10) | 1.42 | 2.37 | 3.6 |
| Particle size distribution (D90/D10) | 1.84 | 5.04 | 0.4 |
| K Value | 5.39 | 20.1 | 62.9 |

As seen from Table 1, silver particles a used in the silver paste composition of the present invention that are spherical and have continuous open pores have a relatively large volume-based cumulative 50% particle diameter D50 of 3.32 μm and have a large BET specific surface area of 3.2 m²/g. As can be seen from the relationship for silver particles b between the cumulative 50% particle diameter D50 of 7.1 μm and the BET specific surface area of 0.4 m²/g, generally, there is a tendency for BET specific surface areas to decrease when the cumulative 50% particle diameters D50 of spherical silver particles are increased, and for BET specific surface areas to increase when the cumulative 50% particle diameters D50 of silver particles are decreased. The silver particles a contained in the silver paste composition of the present invention have a large BET specific surface area of 3.2 m²/g, while they have a relatively large cumulative 50% particle diameter D50 of 3.32 μm. This tendency is contrary to the general relationship between cumulative 50% particle diameters D50 and BET specific surface areas of spherical silver particles, which confirms that silver particles a are porous particles that have a multitude of continuous open pores. The SA value, which is the area of all the void portions present in a cross-section, was determined for the silver particles a shown in FIG. 4 by the above-mentioned method. It was found that silver particles a had an SA value of 30. The fact that silver particles a have a large SA value of 30 also confirms that silver particles a are spherical porous particles that have a multitude of continuous open pores.

As seen from Table 1, the silver particles a used in the silver paste composition of the present invention that are spherical and have continuous open pores have a D90/D50 of 1.29, a D50/D10 of 1.42, and a D90/D10 of 1.84 and each of these figures is 2 or less. Further, the fact that silver particles a have a small D90/D10 of 1.84 confirms that the dispersion of the particle size distribution is small and the particle size distribution is sharp, and the particles are of nearly equal size. Silver particles b, which do not have continuous open pores, have a large D90/D10 of 5.04 and flaky silver particles c have a small D90/D10 of 0.4, which confirms that silver particles b and silver particles c are not uniform in their particle size distributions.

As seen from Table 1, the silver particles a used in the silver paste composition of the present invention that are spherical and have continuous open pores have a small K value of 5.39, which is the ratio of the specific surface area SS, derived from the volume-based cumulative 50% particle diameter D50 of the silver particles and the theoretical density of the silver particles, to the BET specific surface area BS. The fact that the K value of silver particles a is as small as 5.39 confirms that silver particles a have the form of a nearly perfect sphere. On the other hand, silver particles b which do not have continuous open pores and flaky silver particles c have a specific surface area SS that is large relative to the BET specific surface area BS, and have a large K value, which is the ratio of the specific surface area SS to the BET specific surface area BS. The K value of silver particles b is 20.1, and the K value of silver particles c is 62.9. The K value of silver particles b and the K value of silver particles c are much larger than the K value of silver particles a, which confirms that silver particles b and silver particles c have the forms of nearly formless particles.

### Example a

### Mixing (A) Silver Particles with a (B) Resin

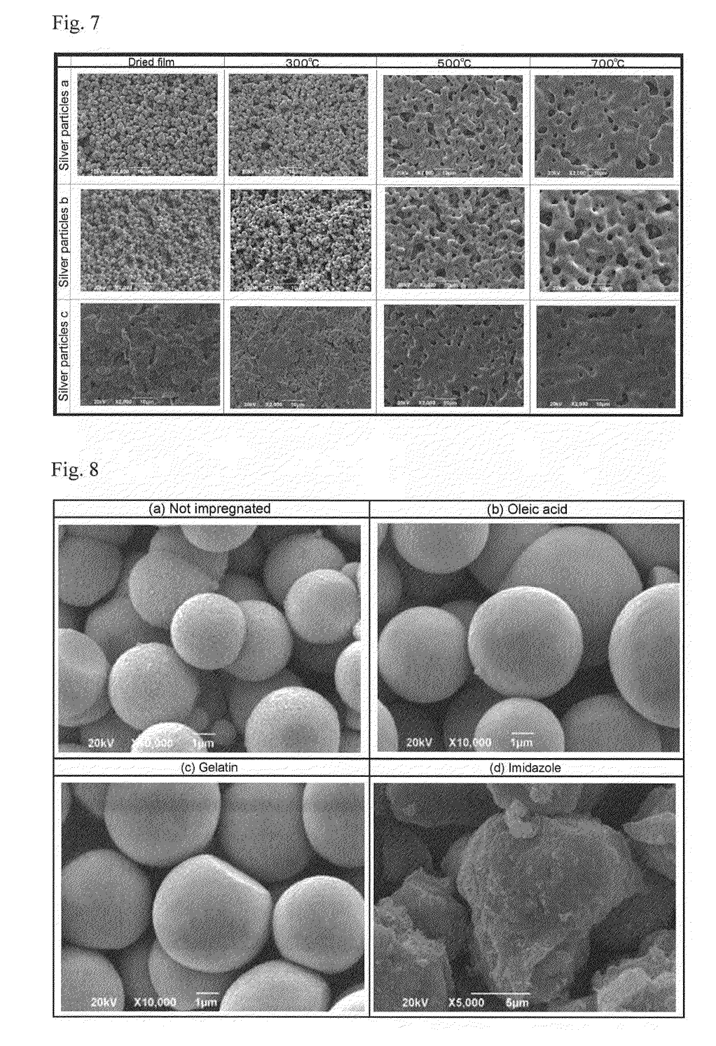

100 Parts by mass of silver particles a for component (A) and 5 parts by mass of ethyl cellulose, which is a resin for component (B), were kneaded together by means of a three-roll mill to obtain a silver paste composition. The obtained silver paste composition was dried at 80° C. for 30 minutes to obtain a dried film. The silver paste composition was cured by heating at 300° C. for 1 hour, at 500° C. for 1 hour, or at 700° C. for 1 hour to obtain cured products. SEM photomicrographs of the obtained dried film and cured products at a magnification of 2,000 times are shown in FIG. 7.

### Comparative Examples b and c

Silver paste compositions were individually obtained in substantially the same manner as in Example a except that the silver particles were changed to silver particles b or silver particles c. Using the obtained silver paste compositions, cured products were obtained in the same manner as in Example a. SEM photomicrographs of the obtained cured products at a magnification of 2,000 times are shown in FIG. 7.

As shown in FIG. 7, with respect to the silver paste composition using silver particles a that are spherical and have continuous open pores, the sintered film obtained by heating at 700° C. had few voids. On the other hand, as shown in FIG. 7, with respect to the silver paste composition using silver particles b that do not have continuous open pores and the silver paste composition using flaky silver particles c, the sintered films obtained by heating at 700° C. had many voids. From the silver paste composition a using silver particles a that are spherical and have continuous open pores, a smooth sintered film was obtained, as compared to the silver paste composition using silver particles b that do not have continuous open pores and the silver paste composition using flaky silver particles c.

### Example 1

100 Parts by mass of silver particles a for component (A) that are spherical and have continuous open pores, and 10 parts by mass of carboxyl group-terminal acrylonitrile-butadiene (HycarCTBN; hereinafter, also referred to as “CTBN”; manufactured by Ube Industries, Ltd.), which is a liquid thermoplastic elastomer having a glass transition temperature of 25° C. or lower and being in a liquid state or being dissolved in an organic solvent, for component (B), were mixed with each other to obtain silver particles having CTBN contained in the continuous open pores of the silver particles a. The amount of CTBN contained was 10% by mass, based on the total mass of silver particles a and CTBN (100% by mass). 110 Parts by mass of silver particles a containing component (A) and component (B) and having CTBN in an amount of 10% by mass contained in the continuous open pores, 90 parts by mass of an epoxy resin for component (B) (liquid bisphenol A epoxy resin; epoxy equivalent: 180 g/eq; weight average molecular weight (Mw): 360), and 10 parts by mass of 2-ethyl-4-methylimidazole (2E4MZ), which is a curing agent for component (D), were kneaded together by means of a three-roll mill to obtain a silver paste composition. The obtained silver paste composition was cured using a dryer at 200° C. for 30 minutes to obtain a conductor.

### Example 2

A silver paste composition was obtained in substantially the same manner as in Example 1 except that silver particles a having a thermoplastic elastomer (CTBN) for component (B) in an amount of 20% by mass contained in the continuous open pores of the silver particles a for component (A) were used, and that the silver particles a containing component (A) and component (B), an epoxy resin for component (B), and a curing agent for component (D) were mixed according to the formulation shown in Table 2. The obtained silver paste composition was cured in the same manner as in Example 1 to obtain a conductor.

### Example 3

A silver paste composition was obtained in substantially the same manner as in Example 1 except that silver particles a that did not have thermoplastic elastomer (CTBN) for component (B) in an amount of 10% by mass contained in the continuous open pores of silver particles a for component (A) were used, and that the silver particles for component (A), an epoxy resin for component (B), and a curing agent for component (D) were mixed according to the formulation shown in Table 2. The obtained silver paste composition was cured in the same manner as in Example 1 to obtain a conductor.

### Comparative Examples 1 to 3

Silver paste compositions were individually obtained in substantially the same manner as in Example 1 except that silver particles b that do not have continuous open pores were used, and the silver particles, an epoxy resin, CTBN, and a curing agent were mixed according to the formulation shown in Table 2. The obtained silver paste compositions were individually cured in the same manner as in Example 1 to obtain conductors.

The obtained conductors were evaluated by the methods described below. The results are shown in Table 2.

<Measurement of Elastic Moduli>

The silver paste compositions in the Comparative Examples and Examples were individually applied to a Teflon (registered trademark) sheet such that the thickness was the same as two layers of heat-resistant tape, and cured at 200° C. for 30 minutes. After curing, the resultant test specimen was removed from the Teflon (registered trademark) sheet, and subjected to annealing at 150° C. for 10 minutes. From the resultant cured film, a test specimen having a size of 1 cm×4 cm was cut out and used as a specimen for a flexural test. The test specimen was subjected to aging at 150° C. for 0 hours, 20 hours, 100 hours, and 1,000 hours. With respect to each of the test specimens, the flexural modulus was measured on an Autograph, manufactured by Shimadzu Science Corporation.

<Measurement of Electrical Resistivity>

Using each of the silver paste compositions in the Examples and Comparative Examples, a zigzag pattern having a length of 71 mm, a width of 1 mm, and a thickness of 20 μm was printed on an alumina substrate having a width of 20 mm, a length of 20 mm, and a thickness of 1 mm using a 250-mesh stainless steel screen, and cured in air at 200° C. for 30 minutes to form an external electrode. The thickness of the zigzag pattern was determined with a surface roughness profile measurement machine (product name: Surfcom 1400), manufactured by Tokyo Seimitsu Co., Ltd., based on the average of the values at 6 points where measurements were made in the direction across the pattern. After curing, the resistivity was measured by the four probe method using an LCR meter. Based on the measured values, using the formula (3) below, the ratio of the increase in resistivity as compared to the silver paste composition in Comparative Example 3 using silver particles that have continuous open pores and that do not contain a thermoplastic elastomer (CTBN) was derived.

Ratio of increase in electrical resistivity=(Specific electrical resistance for one of the Examples and Comparative Examples)/(Specific electrical resistance in Comparative Example 3) (3)

<Measurement of Strength>

Using each of the silver paste compositions in the Examples and Comparative Examples, a dot pattern was screen printed on a 20 mm² alumina substrate, and a 1.5×3.0 mm alumina chip was placed on the printed pattern and cured at 200° C. for 30 minutes. Then, the bonding surface was pushed from the side using a push-pull gauge, and the value for the time when the alumina chip came off was taken as the measured value, and the bonding strength was calculated using the following formula (4).

Bonding strength (kN/cm²)=Measured value (kgf)×9.8/0.03 (cm²) (4)

TABLE 2

| | | Comparative | | Comparative | | Comparative | |
|---|---|---|---|---|---|---|---|
| | | Example 1 | Example 1 | Example 2 | Example 2 | Example 3 | Example 3 |
| Formulation | Silver particles b | 100 | — | 100 | — | 100 | — |
| (Parts by | Silver particles a | — | — | — | — | — | 100 |
| mass) | Silver particles a | — | 110 | — | — | — | — |
| | containing CTBN | | | | | | |
| | in an amount of | | | | | | |
| | 10% by mass | | | | | | |
| | Silver particles a | — | — | — | 120 | — | — |
| | containing CTBN | | | | | | |
| | in an amount of | | | | | | |
| | 20% by mass | | | | | | |
| | CTBN | 10 | — | 20 | — | — | — |
| | Epoxy resin | 90 | 90 | 80 | 80 | 100 | 100 |
| | Curing agent | 10 | 10 | 10 | 10 | 10 | 10 |
| Physical | Elastic modulus | 5 | 5 | 3 | 3 | 9 | 8 |
| properties | [Gpa] | | | | | | |
| | Resistivity | 3.3 | 2.04 | 3.45 | 2.02 | 3 | 2 |
| | [×10E−04 Ω · cm] | | | | | | |
| | Ratio of increase | 10 | 2 | 15 | 1 | — | — |
| | in electrical | | | | | | |
| | resistivity [%] | | | | | | |
| | Strength [kN/cm²] | 2 | 2.5 | 1.8 | 2.2 | 2.5 | 2.3 |

As seen from Table 2, when a comparison is made between Example 1 and

Comparative Example 1 in which the same amount of CTBN was incorporated, the conductor obtained using the silver paste in Example 1 using silver particles a having CTBN contained in the continuous open pores thereof reduced the increase in electrical resistivity to one-fifth of that in Comparative Example 1 while maintaining the elastic modulus similar to those in Comparative Examples 1 and 3. When a comparison is made between Example 2 and Comparative Example 2 in which the same amount of CTBN was incorporated, the conductor obtained using the paste in Example 2 using silver particles a having CTBN contained in the continuous open pores thereof reduced the increase in electrical resistivity to one-fifteenth of that in Comparative Example 2 while maintaining the elastic modulus similar to that in Comparative Example 2, and further exhibited a more excellent value for strength than Comparative Example 2. In Example 3 using silver particles a having no CTBN for component (B) contained in the continuous open pores of the silver particles a, the resistivity was suppressed and the strength was maintained without much change, as compared to Comparative Example 3.

### Example 4

100 Parts by mass of silver particles a for component (A) that are spherical and have continuous open pores, and 10 parts by mass of a novolak phenolic resin (hydroxyl equivalent: 110 g/eq) as a curing agent for component (D) were mixed with each other to obtain silver particles having a phenolic resin contained in the continuous open pores of the silver particles a. The amount of the phenolic resin contained was 10% by mass, based on the total mass of the silver particles a and the phenolic resin (100% by mass). 110 Parts by mass of silver particles a for component (A) having the phenolic resin for component (D) in an amount of 10% by mass contained in the continuous open pores, and 100 parts by mass of an epoxy resin for component (B) (liquid bisphenol A epoxy resin; epoxy equivalent: 180 g/eq; weight average molecular weight (Mw): 360) were kneaded together by means of a three-roll mill to obtain a silver paste composition. The ratio of the hydroxyl equivalent of the phenolic curing agent for component (D) to the epoxy equivalent (g/eq) of the epoxy resin for component (B) (hydroxyl equivalent/epoxy equivalent) was 0.61.

### Example 5

A silver paste composition was obtained in substantially the same manner as in Example 4 except that silver particles a for component (A) having a phenolic resin as a curing agent for component (D) in an amount of 20% by mass contained in the continuous open pores were used, and the silver particles a and an epoxy resin for component (B) were mixed according to the formulation shown in Table 3.

### Example 6

100 Parts by mass of silver particles a for component (A) that are spherical and have continuous open pores, and 10 parts by mass of 2-ethyl-4-methylimidazole (2E4MZ) as a curing agent for component (D) were mixed with each other to obtain silver particles having the curing agent for component (D) contained in the continuous open pores of the silver particles a. The amount of 2-ethyl-4-methylimidazole (2E4MZ) for component (D) was 10% by mass, based on the total mass of the silver particles a for component (A) and 2E4MZ for component (D) (100% by mass). 110 Parts by mass of silver particles a for component (A) having 2-ethyl-4-methylimidazole (2E4MZ) for component (D) in an amount of 10% by mass contained in the continuous open pores, and 100 parts by mass of an epoxy resin for component (B) (liquid bisphenol A epoxy resin; epoxy equivalent: 180 g/eq; weight average molecular weight (Mw): 360) were kneaded together by means of a three-roll mill to obtain a silver paste composition. The amount of the curing agent for component (D) was 10 parts by mass, relative to the epoxy equivalent of the epoxy resin for component (B).

### Example 7

A silver paste composition was obtained in substantially the same manner as in Example 5 except that silver particles a having 2-ethyl-4-methylimidazole (2E4MZ) as a curing agent for component (D) in an amount of 20% by mass contained in the continuous open pores of the silver particles a for component (A) were used, and the silver particles a and an epoxy resin for component (B) were mixed according to the formulation shown in Table 3.

### Comparative Examples 4 and 5

Silver paste compositions were individually obtained in substantially the same manner as in Example 3 except that silver particles b that do not have continuous open pores were used, and the silver particles, an epoxy resin, and a phenolic resin were mixed according to the formulations shown in Table 3.

The obtained conductors were evaluated by the method described below. The results are shown in Table 3.

<Measurement of Viscosity Increase Ratios>

The viscosities (V₀) of silver paste compositions were measured, immediately after production, at 10 rpm using an HBT viscometer, manufactured by Brookfield Engineering, and a No. 14 spindle. With respect to silver paste compositions stored at 25° C. for 24 hours and 240 hours, respectively, after production, the viscosities (V₁) were measured under the same conditions. From V₀ and V₁, the viscosity increase ratio (%) was calculated using the following formula (5).

Viscosity increase ratio (%)=V₁/V₀×100 (5)

TABLE 3

| | | Comparative | | | Comparative | | |
|---|---|---|---|---|---|---|---|
| | | example 4 | Example 4 | Example 5 | example 5 | Example 6 | Example 7 |
| Formulation | Silver particles b | 100 | — | — | 100 | — | — |
| (Parts by | Silver particles a | — | — | — | — | — | — |
| mass) | Silver particles a | — | 110 | — | — | — | — |
| | containing | | | | | | |
| | phenolic resin in | | | | | | |
| | an amount of 10% | | | | | | |
| | by mass | | | | | | |
| | Silver particles a | — | — | 120 | — | — | — |
| | containing | | | | | | |
| | phenolic resin in | | | | | | |
| | an amount of 20% | | | | | | |
| | by mass | | | | | | |
| | Silver particles a | — | — | — | — | 110 | — |
| | containing curing | | | | | | |
| | agent (2E4MZ) in | | | | | | |
| | an amount of 10% | | | | | | |
| | by mass | | | | | | |
| | Silver particles a | — | — | — | — | — | 120 |
| | containing curing | | | | | | |
| | agent (2E4MZ) in | | | | | | |
| | an amount of 20% | | | | | | |
| | by mass | | | | | | |
| | Epoxy resin | 100 | 100 | 100 | 100 | 100 | 100 |
| | Phenol | 10 | — | — | — | — | — |
| | Curing agent | — | — | — | — | 10 | — |
| Physical | Viscosity increase | 50 | 1 | 1 | 12 | 3 | 7 |
| properties | ratio [25° C./24 h] % | | | | | | |
| | Viscosity increase | Gelled | 5 | 10 | Gelled | 54 | 69 |
| | ratio [25° C./240 h] % | | | | | | |

As can be seen from Table 3, the results confirm that the viscosity increase ratio was remarkably suppressed after 24 hours or 240 hours in the silver paste compositions in Examples 4 and 5 using silver particles a having a phenolic resin as a curing agent for component (D) contained in the continuous open pores, as compared to the silver paste compositions in Comparative Examples 4 and 5. Further, as can be seen from Table 3, the results confirms that the viscosity increase ratio was suppressed after 24 hours or 240 hours in the silver paste composition in Examples 6 and 7 using silver particles a having 2-ethyl-4-methylimidazole (2E4MZ) as a curing agent for component (D) contained in the continuous open pores, as compared to the silver paste compositions in Comparative Examples 4 and 5.

### Example 8

80 Parts by mass of silver particles a for component (A) that are spherical and have continuous open pores, 20 parts by mass of an epoxy resin for component (B) (liquid bisphenol A epoxy resin; epoxy equivalent: 180 g/eq; weight average molecular weight (Mw): 360), and 10 parts by mass of 2-ethyl-4-methylimidazole (2E4MZ) as a curing agent for component (D), were kneaded together by means of a three-roll mill to obtain a silver paste composition. In the silver paste composition, the amount of the curing agent for component (D) was 50 parts by mass, relative to 100 parts by mass of the epoxy resin for component (B). The obtained silver paste composition was cured using a dryer at 200° C. for 30 minutes to obtain a conductor.

### Example 9

80 Parts by mass of silver particles a for component (A) that are spherical and have continuous open pores, 20 parts by mass of an epoxy resin for component (B) (liquid bisphenol A epoxy resin; epoxy equivalent: 180 g/eq; weight average molecular weight (Mw): 360), 10 parts by mass of 2-ethyl-4-methylimidazole (2E4MZ) as a curing agent for component (D), and 1 part by mass of isostearic acid as a fluxing agent for component (E), were kneaded together by means of a three-roll mill to obtain a silver paste composition. In the silver paste composition, the amount of the curing agent for component (D) was 50 parts by mass, relative to 100 parts by mass of the epoxy resin for component (B). Further, in the silver paste composition, the amount of the fluxing agent for component (E) was 1.25 parts by mass, relative to 100 parts by mass of the total of the silver particles for component (A) and the fluxing agent for component (E). The obtained silver paste composition was cured using a dryer at 200° C. for 30 minutes to obtain a conductor.

### Example 10

80 Parts by mass of silver particles a that are spherical and have continuous open pores, and 10 parts by mass of isostearic acid as a fluxing agent for component (E) were mixed with each other to obtain silver particles having the fluxing agent for component (E) contained in the continuous open pores of the silver particles a for component (A). The amount of the fluxing agent contained was 10 parts by mass, relative to 100 parts by mass of the total of the silver particles a for component (A) and the fluxing agent for component (E). The silver particles a having 10 parts by mass of the fluxing agent contained in the continuous open pores, an epoxy resin for component (B), and 10 parts by mass of 2-ethyl-4-methylimidazole (2E4MZ) as is a curing agent for component (D) were kneaded together by means of a three-roll mill to obtain a silver paste composition having the formulation shown in Table 4. In the silver paste composition, the amount of the curing agent for component (D) was 50 parts by mass, relative to 100 parts by mass of the epoxy resin for component (B). Further, in the silver paste composition, the amount of the fluxing agent for component (E) was 11.1 parts by mass, relative to 100 parts by mass of the total of the silver particles for component (A) and the fluxing agent for component (E). The obtained silver paste composition was cured using a dryer at 200° C. for 30 minutes to obtain a conductor.

### Comparative Example 6

A silver paste composition was obtained in substantially the same manner as in Example 7 except that silver particles b that do not have continuous open pores were used, and the silver particles, an epoxy resin, a fluxing agent, and a curing agent were mixed according to the formulation shown in Table 4. The obtained silver paste composition was cured using a dryer at 200° C. for 30 minutes to obtain a conductor.

### Comparative Example 7

A silver paste composition was obtained in substantially the same manner as in Example 7 except that flaky silver particles c were used, and the silver particles, an epoxy resin, a fluxing agent, and a curing agent were mixed according to the formulation shown in Table 4. The obtained silver paste composition was cured using a dryer at 200° C. for 30 minutes to obtain a conductor.

The obtained conductors were evaluated by the method described below. The results are shown in Table 4.

<Measurement of Resistivity>

Using each of the silver paste compositions in the Examples and Comparative Examples, a zigzag pattern having a length of 71 mm, a width of 1 mm, and a thickness of 20 μm was printed on an alumina substrate having a width of 20 mm, a length of 20 mm, and a thickness of 1 mm using a 250-mesh stainless steel screen, and cured in air at 200° C. for 30 minutes to form an external electrode. The thickness of the zigzag pattern was determined by a surface roughness profile measurement machine (product name: Surfcom 1400), manufactured by Tokyo Seimitsu Co., Ltd., based on the average of the values at 6 points where measurements were made in the direction across the pattern. After curing, the resistivity was measured by the four probe method using an LCR meter.

TABLE 4

| | | Comparative | Comparative | | | |
|---|---|---|---|---|---|---|
| | | example 6 | example 7 | Example 8 | Example 9 | Example 10 |
| Formulation | Silver particles b | 80 | — | — | — | — |
| (Parts by | Silver particles c | — | 80 | — | — | — |
| mass) | Silver particles a | — | — | 80 | 80 | — |
| | Silver particles a | — | — | — | — | 80 |
| | containing fluxing | | | | | |
| | agent in an amount | | | | | |
| | of 10% by mass | | | | | |
| | Epoxy resin | 20 | 20 | 20 | 20 | 20 |
| | Fluxing agent | 1 | 1 | 0 | 1 | — |
| | Curing agent | 10 | 10 | 10 | 10 | 10 |
| Physical | Resistivity | 4 × 10⁻³ | 5 × 10⁻⁴ | 3 × 10⁻⁴ | 2 × 10⁻⁴ | 8 × 10⁻⁵ |
| properties | [Ω · cm²] | | | | | |

As seen from Table 4, there was a reduction in resistivity for the conductors in Examples 8 and 9, which were obtained by curing the silver paste composition using silver particles a that are spherical and have continuous open pores, as compared to the conductors in Comparative Example 6 and 7, which were obtained by curing the silver paste composition using silver particles b that do not have continuous open pores or using flaky silver particles. For the conductor in Example 10, which was obtained by curing the silver paste composition using silver particles a having a fluxing agent contained in the continuous open pores, there was a reduction in resistivity by two or more orders of magnitude compared to Comparative Example 6 and by one or more orders of magnitude compared to Comparative Example 7.

### Example 11

Silver particles a for component (A) that are spherical and have continuous open pores and oleic acid (concentration: 1%) as a dispersant for component (C) were mixed with each other, so that the oleic acid for component (C) was contained in the continuous open pores of the silver particles a for component (A), and the oleic acid was deposited on the surfaces. The amount of the oleic acid for component (C) was 0.5% by mass, based on the total mass of the silver particles a for component (A) and the oleic acid for component (C) (100% by mass). FIG. 8(b) shows an SEM photomicrograph of silver particles a in Example 11 taken at a magnification of 10,000 times. FIG. 8(a) shows an SEM photomicrograph, taken at a magnification of 10,000 times, of silver particles a for component (A) that are spherical and have continuous open pores and that do not contain a dispersant for component (C).

### Example 12

Silver particles a for component (A) that are spherical and have continuous open pores and gelatin (concentration: 1%) as a dispersant for component (C) were mixed with each other, so that the gelatin for component (C) was contained in the continuous open pores of the silver particles a for component (A), and the gelatin was deposited on the surfaces. The amount of the gelatin for component (C) was 0.5% by mass, based on the total mass of the silver particles a for component (A) and the gelatin for component (C) (100% by mass). FIG. 8(c) shows an SEM photomicrograph of silver particles a in Example 12 taken at a magnification of 10,000 times.

### Example 13

Silver particles a for component (A) that are spherical and have continuous open pores, and imidazole (concentration: 1%) as a dispersant for component (C), were mixed with each other, so that the imidazole for component (C) was contained in the continuous open pores of the silver particles a for component (A), and the imidazole was deposited on the surfaces. The amount of the imidazole for component (C) was 0.8% by mass, based on the total mass of the silver particles a for component (A) and the imidazole for component (C) (100% by mass). FIG. 8(d) shows an SEM photomicrograph of silver particles a in Example 13 taken at a magnification of 5,000 times.

As shown in FIG. 8(a), silver particles a that are spherical and have continuous open pores, and that are not impregnated with a dispersant for component (C), had a finely uneven structure on the surface thereof. As shown in FIGS. 8(b) and 8(c), in silver particles a that have been mixed with oleic acid or gelatin for component (C), the oleic acid or gelatin was smoothly deposited on the surfaces of the silver particles a, thereby presumably improving the dispersibility of the silver particles having a (C) dispersant contained in the continuous open pores thereof, and the specific gravity of the paste was increased. On the other hand, as shown in FIG. 8(d), in silver particles a that have been mixed with imidazole, the imidazole was deposited in layers on the surfaces of silver particles a, so that the particles did not form into smooth spheres.

### INDUSTRIAL APPLICABILITY

In the present invention, there can be provided a silver paste composition that comprises silver particles that are spherical and have continuous open pores, and a resin, and that exhibits such excellent properties as suppression of an increase in electrical resistance and viscosity and a reduction in electrical resistivity, and which composition can be advantageously used in, for example, forming a conductor or an electronic part, and a method for producing the same. The silver paste composition of the present invention can be advantageously used as a conductor, such as an electronic circuit or an electrode, a conductive paste for a plating undercoat, a resistor, or an electrode, a semiconductor encapsulation agent, or a conductive bonding agent, such as a die attach adhesive. A conductor comprising a cured product obtained by curing the silver paste composition of the present invention can be advantageously used as an electronic part for, for example, a chip capacitor, an end face base electrode of a chip resistor, a variable resistor, or a film substrate circuit, and is useful from an industrial point of view.

1. A silver paste composition comprising:
(A) silver particles that are spherical and have continuous open pores; and
a (B) resin and/or a (C) dispersant,
wherein the (A) silver particles have a volume-based cumulative 50% particle diameter D50 of 0.5 to 6 μm, as measured by a particle size distribution measurement method based on image analysis, and a BET specific surface area of 1 to 8 m²/g,
and the (B) resin is at least one resin selected from the group consisting of a thermoplastic resin and a thermosetting resin.

2. The silver paste composition according to claim 1, wherein the (B) resin is contained in the silver paste composition and a mass ratio of the (A) silver particles to the (B) resin is 30:70 to 99:1.

3. The silver paste composition according to claim 1, further comprising a (D) curing agent.

4. The silver paste composition according to claim 1, further comprising at least one component selected from the group consisting of a (E) fluxing agent and a (F) curing accelerator.

5. The silver paste composition according to claim 4, further comprising a (D) curing agent, and wherein the continuous open pores of the (A) silver particles contain at least one substance selected from the group consisting of the (B) resin, the (C) dispersant, the (D) curing agent, the (E) fluxing agent, and the (F) curing accelerator.

6. The silver paste composition according to claim 5, wherein the amount of the substance contained in the continuous open pores of the (A) silver particles is 1 to 50% by mass, based on the total mass of the (A) silver particles and the substance.

7. (canceled)

8. (canceled)

9. The silver paste composition according to claim 1, wherein the (A) silver particles have a volume-based cumulative 10% particle diameter D10 of 0.5 to 2.5 μm, a volume-based cumulative 90% particle diameter D90 of 3 to 6 μm, and a D90/D10 of 1.5 to 2.5, as measured by a particle size distribution measurement method based on image analysis.

10. The silver paste composition according to claim 1, wherein the composition has a value K of 3≦K≦72, wherein the value K is expressed by the following equation (2), which is calculated from the specific surface area SS of the (A) silver particles expressed by the following equation (1) and the BET specific surface area BS of the (A) silver particles as measured by the BET method:
SS=6/ρd (1)
, wherein ρ represents the theoretical density of the (A) silver particles that contain no resin in the continuous open pores, and d represents the volume-based cumulative 50% particle diameter D50 of the (A) silver particles, as measured by a particle size distribution measurement method based on image analysis,
K=SS/BS×100 (2).

11. (canceled)

12. The silver paste composition according to claim 10, wherein the (B) resin is a thermoplastic resin, said thermoplastic resin being at least one resin selected from the group consisting of a polystyrene resin, an acrylic resin, a polycarbonate resin, a polyamide resin, a polyamide-imide resin, and a liquid thermoplastic elastomer having a glass transition temperature of 25° C. or lower, and being in a liquid state or being dissolved in an organic solvent.

13. The silver paste composition according to claim 10, wherein the (B) resin is a thermosetting resin, said thermosetting resin being at least one resin selected from the group consisting of an epoxy resin, a cyanate resin, a urethane resin, and an unsaturated polyester resin.

14. The silver paste composition according to claim 1, wherein the (C) dispersant is at least one dispersant selected from the group consisting of a fatty acid or a salt thereof, a surfactant, an organometal, and a protective colloid.

15. The silver paste composition according to claim 3, wherein the (D) curing agent is at least one curing agent selected from the group consisting of a phenolic curing agent, an amine curing agent, an imidazole curing agent, and an acid anhydride curing agent.

16. The silver paste composition according to claim 4, wherein the (E) fluxing agent is at least one fluxing agent selected from the group consisting of a rosin fluxing agent, a modified rosin fluxing agent, and an organic acid fluxing agent.

17. The silver paste composition according to claim 4, wherein the (F) curing accelerator is at least one curing accelerator selected from the group consisting of an imidazole and a tertiary amine.

18. (canceled)

19. An electronic part that is formed using the silver paste composition according to claim 1.

20. A method for producing a silver paste composition, the method comprising the steps of:
adding a silver salt and a polycarboxylic acid to a liquid phase to obtain an aqueous solution containing silver ions;
then adding a reducing agent to the obtained aqueous solution to cause, in the liquid phase, precipitation of (A) silver particles that have continuous open pores; and
mixing with each other the obtained (A) silver particles that have continuous open pores, and a (B) resin.

21. The method for producing a silver paste composition according to claim 20, wherein the silver salt is at least one silver salt selected from the group consisting of silver nitrate, silver sulfate, silver carbonate, and silver chloride.

22. (canceled)

23. The method for producing a silver paste composition according to claim 20, wherein the reducing agent is ascorbic acid.

24. The method for producing a silver paste composition according to claim 20, wherein a ratio of amounts of the silver salt, the polycarboxylic acid, and the reducing agent, in terms of a molar ratio, is 1:0.1 to 0.5:0.5 to 1.

25. The method for producing a silver paste composition according to claim 20, wherein the polycarboxylic acid is at least one polycarboxylic acid selected from the group consisting of citric acid, malic acid, maleic acid, and malonic acid.
